(19) United States
(12) Patent Application Publication
(10) Pub. No.: US 2023/0234867 A1
(43) Pub. Date: Jul. 27, 2023

(54) BIOREMEDIATION SYSTEMS FOR WASTEWATER TREATMENT AND METHODS FOR THE USE THEREOF

(71) Applicants: Tahereh KARIMI, Humble, TX (US); Truong Huu NGUYEN, Houston, TX (US); Marcio Luis Busi DA SILVA, Sugar Land, TX (US)

(72) Inventors: Tahereh KARIMI, Humble, TX (US); Truong Huu NGUYEN, Houston, TX (US); Marcio Luis Busi DA SILVA, Sugar Land, TX (US)

(21) Appl. No.: 18/001,303

(22) PCT Filed: Jul. 7, 2021
(86) PCT No.: PCT/US21/40713

§ 371 Date: Dec. 9, 2022

Related U.S. Application Data
(60) Provisional application No. 63/049,498, filed on Jul. 8, 2020.

(51) Int. Cl. C02F 3/30; C02F 3/34; C02F 9/00; C02F 3/00

(52) U.S. Cl. CPC C02F 3/30; C02F 3/341; C02F 3/345; C02F 9/00; C02F 3/005; C02F 2101/20

(57) ABSTRACT

The present disclosure relates to bioremediation systems and methods for wastewater treatment in heavy industry, including the mining industry. A benefit of the systems and methods disclosed herein can include the reduction of heavy metals in wastewater. Another benefit can be the treatment of acidic wastewater to achieve higher pH levels. An additional benefit can be the use of carbon dioxide to raise the pH level of acidic wastewater, or to produce feedstocks for the growth of anaerobic or aerobic microorganisms that are capable of reducing a concentration of heavy metals in wastewater. A benefit of the systems and methods herein can include the treatment of acid mining drainage wastewater, as well as heavy metal removal from other industrial wastewater. Another benefit of the methods and systems disclosed herein can include reduction of excess carbon dioxide from the environment.

### CROSS-REFERENCE

This application is a national stage application of International Patent Application No. PCT/US2021/040713, field Jul. 8, 2021, claims the benefit of U.S. Provisional Application No. 63/049,498, filed Jul. 8, 2020, which is incorporated in its entirety herein by reference.

### FIELD

The present disclosure relates to bioremediation systems and methods for wastewater treatment in heavy industry, including the mining industry. A benefit of the systems and methods disclosed herein can include the reduction of heavy metals in wastewater. Another benefit can be the treatment of acidic wastewater to achieve higher pH levels. An additional benefit can be the use of carbon dioxide to raise the pH level of acidic wastewater, or to produce feedstocks for the growth of anaerobic or aerobic microorganisms that are capable of reducing a concentration of heavy metals in wastewater. A benefit of the systems and methods herein can include the treatment of acid mining drainage wastewater, as well as heavy metal removal from other industrial wastewater. Another benefit of the methods and systems disclosed herein can include reduction of excess carbon dioxide from the environment.

### BACKGROUND

The treatment of wastewater contaminated with toxic metal impurities is a major environmental concern for society. Among these concerns is the considerable and costly problem of treating acid mine drainage from mining operations. Lime addition is the most common method of treatment for acidic wastewater, and though proven effective, it is expensive in the long term and has a high carbon footprint. Electrochemical reactions can increase the pH of acidic wastewater and can remove some soluble heavy metals from solution by precipitation.

Bioremediation presents another alternative, with potential for a cost effective and environmentally sustainable approach to treat wastewater and other contamination resulting from mining activities. Microorganisms such as bacteria or cyanobacteria can be utilized to remove heavy metals and to increase pH levels of acidic effluents. However, many microorganisms may not be able to thrive in wastewater effluents with very low pH, or high concentrations of toxic heavy metals. Currently available methods that can treat large volumes of wastewater, such as effluents generated at mining sites, are very expensive and may lack efficiency. A need remains for wastewater treatments that are robust, cost effective, and accessible for use on an industrial scale.

At the same time, increased demand for power worldwide has led to an excess of carbon dioxide from burning fossil fuels such as oil and gas, contributing substantially to what many are calling a global warming crisis. Industry is so desperate to prevent carbon dioxide from entering the atmosphere that they have resorted to sequestering carbon dioxide from tail pipe emissions and the atmosphere. All currently known methods just remove carbon dioxide from the atmosphere by capturing and storing it under ground. In the short term, they do not actually convert the carbon dioxide back into any other useful material.

There remains a need for systems and methods for wastewater treatment that can provide for effective, practical and cost effective pH adjustment and reduction of heavy metals in wastewater on an industrial scale. There remains a need for systems and methods for wastewater treatment that have a lower carbon footprint and aid in the removal of excess carbon dioxide from the environment or exhaust streams.

### SUMMARY

Embodiments herein are directed to bioremediation systems for wastewater treatment. In various embodiments, the system includes a system wastewater inlet, a system wastewater outlet, an anaerobic reaction vessel, and an aerobic reaction vessel connected by at least one wastewater flow path. In various embodiments, the anaerobic reaction vessel contains an anaerobic reaction solution, wherein the anaerobic reaction solution contains an anaerobic concentration of at least one anaerobic microorganism in an anaerobic wastewater. In various embodiments, the at least one anaerobic microorganism is capable of reducing an anaerobic concentration of metal in the anaerobic wastewater, is capable of increasing an anaerobic pH of the anaerobic wastewater, is capable of reducing an anaerobic concentration of organic compounds in the anaerobic wastewater, or a combination thereof. In various embodiments, the aerobic reaction vessel contains an aerobic reaction solution, wherein the aerobic reaction solution contains an aerobic concentration of at least one aerobic microorganism in an aerobic wastewater. In various embodiments, the at least one aerobic microorganism contains a metalloprotein, is capable of reducing an aerobic concentration of CO2, is capable of decreasing an aerobic concentration of metal from the aerobic wastewater, or a combination thereof.

In certain embodiments, the bioremediation system further includes an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source. In such embodiments, the electrochemical reaction vessel is connected by the at least one wastewater flow path to the anaerobic reaction vessel, the aerobic reaction vessel, or a combination thereof.

In certain embodiments, the carbon dioxide source includes a carbon dioxide inlet. In certain embodiments, the power source includes sunlight, a solar power source, an electrical power source, or a combination thereof. In certain embodiments, the power source is configured to provide a voltage of from about 0.7 Volts to about 10 Volts, or a current of from about 60 mA to about 100 mA.

In certain embodiments, the electrochemical reaction vessel, the anaerobic reaction vessel, the aerobic reaction vessel, or any combination thereof, has a volume of from about 1000 liters to about 1 million liters. In certain embodiments, the anaerobic concentration ranges from about 10⁷ to about 10⁹ cells per milliliter, or an optical density of about 0.6 to about 1.0. In certain embodiments, the aerobic concentration ranges from about 10⁷ to about 10⁹ cells per milliliter, or an optical density of about 0.6 to about 1.0.

In certain embodiments, the electrochemical reaction vessel contains an electrochemical reaction buffer, wherein the electrochemical reaction buffer includes an amount of sodium chloride, sodium hydroxide, sodium carbonate, calcium carbonate, potassium carbonate, potassium chloride, potassium hydroxide, magnesium chloride, or a combination thereof. In certain embodiments, the electrochemical reaction vessel, the anaerobic reaction vessel, and the aerobic reaction vessel each independently includes a vessel wall, wherein the vessel wall includes a cement material, a fiberglass material, a fiber material, a steel material, a natural formation, a plastic material, a gel material, or a combination thereof.

In certain embodiments, the anaerobic reaction vessel further includes an anaerobic wastewater inlet, an anaerobic wastewater outlet, an anaerobic nutrient inlet, and an anaerobic biomass outlet. In such embodiments, the aerobic reaction vessel further includes an aerobic wastewater inlet, an aerobic wastewater outlet, an aerobic nutrient inlet, and an aerobic biomass outlet, wherein the at least one wastewater fluid path connects the anaerobic wastewater inlet to the aerobic wastewater outlet, or the at least one wastewater fluid path connects the aerobic wastewater inlet to the anaerobic wastewater outlet. In certain embodiments, the bioremediation system further includes an aerobic biomass fluid flow path connecting the aerobic reaction vessel and the anaerobic reaction vessel.

In certain embodiments of a bioremediation system, the at least one anaerobic microorganism is capable of reducing a concentration of sulfate and increasing a concentration of sulfide in the anaerobic wastewater. In certain embodiments, the at least one anaerobic microorganism is capable of oxidizing the anaerobic concentration of organic compounds in the anaerobic wastewater. In certain embodiments, the at least one anaerobic microorganism is capable of producing sulfide.

In certain embodiments, the at least one anaerobic microorganism includes a microorganism selected from the group consisting of Desulfovibrio desulfuricans, Desulfovibrio vulgaris, Desulfovibrio gigas, Caldivirga maquilingensis, Desulfatibacillum alkenivorans, Desulfotomaculum nigrificans, Desulfococcus multivorans, Thermodesulfovibrio yellowstonii, Desulfovibrio aespoeensis, Desulfovibrio aerotolerans, Desulfovibrio fructosivorans, Desulfococcus oleovorans, Desulfovibrio aminophilus, Desulfovibrio ferrireducens, Desulfovibrio salexigens, Desulfovibrio africanus, Archaeoglobus fulgidus, Desulfococcus biacutus, Desulfatibacillum aliphaticivorans, Desulfatirhabdium butyrativorans, Desulfofaba gelida, Desulfovibrio capillatus, Desulfosporomusa spp., Desulfovibrio acrylicus, Desulfovibrio legallii, Desulfosarcina alkanivorans, Desulfatiferula berrensis, Desulfobacula toluolica, Desulfovibrio frigidus, Desulfofaba hansenii, Desulfovibrio senezii, Desulfovibrio arcticus, Thermodesulfobium narugense, Desulfovibrio burkinensis, Thermodesulfobium acidiphilum, Thermocladium modestius, Caldimicrobium rimae, Desulfosarcina ovata, Thermodesulfobacterium hveragerdense, Desulfovibrio alcoholivorans, Desulfovibrio singaporenus, Caldimicrobium thiodismutans, Desulfosporosinus orientis, Desulfovibrio marinus, Desulfatitalea tepidiphila, Desulfofaba fastidiosa, Desulfovibrio ferrophilus, Desulfovibrio bizertensis, Desulfovibrio biadhensis, Desulfatiferula olefinivorans, Desulfobacula phenolica, Dehalococcoides spp., Geobacteria spp., Acetobacterium woodi, Clostridium ljungdahlii, Moorella thermoacethica, and methanotrophic bacteria, or a combination thereof.

In certain embodiments, the at least one aerobic microorganism includes at least one recombinant aerobic microorganism that expresses at least one protein of at least one aerobic genetic pathway, wherein the at least one aerobic genetic pathway provides to the at least one aerobic microorganism one or more of a resistance to a high concentration of heavy metals, a resistance to a low pH level, a production of one or more of an alkaline organic molecule, sodium bicarbonate, ammonia, acetate, and an electron donor; and combinations thereof.

In certain embodiments, the at least one aerobic microorganism includes a microorganism selected from the group consisting of an acidophilic microorganism, Galdieria sulphuraria, a bicarbonate producing species, an alkaline producing species, Spirulina platensis, a Cyanobacteria, Synechococcus elongatus, Synechocystis spp., and a recombinant aerobic microorganism that expresses a higher amount of at least one metalloprotein relative to a control aerobic microorganism.

In certain embodiments of a bioremediation system, the anaerobic reaction vessel and the aerobic reaction vessel include a sample port, an optical density reader, a turbidity reader, or a combination thereof. In certain embodiments, the bioremediation system further includes a pH meter connected to at least one of the system wastewater inlet, the system wastewater outlet, the electrochemical wastewater inlet, the electrochemical wastewater outlet, the aerobic wastewater inlet, the aerobic wastewater inlet, or a combination thereof. In certain embodiments, the bioremediation system further includes a heavy metal detector connected to at least one of the system wastewater inlet, the system wastewater outlet, the electrochemical wastewater outlet, the aerobic wastewater inlet, the aerobic wastewater inlet, or a combination thereof.

In some embodiments of a bioremediation system, the electrochemical reaction vessel, the anaerobic reaction vessel, the aerobic reaction vessel, or any combination thereof, is mounted on or among one or more vehicles. In certain embodiments, the electrochemical reaction vessel, the anaerobic reaction vessel, the aerobic reaction vessel, or any combination thereof, is located within 0.3 kilometers of an industrial site and connected to the industrial site by a gas flow path from the industrial site to the carbon dioxide source, or a wastewater flow path from the industrial site to the system wastewater inlet, or a combination thereof. In certain embodiments, the aerobic reaction vessel further comprises a gas flow path connected to the carbon dioxide source, a gas flow path connected to an air source, or a combination thereof.

Embodiments herein are directed to methods of treating wastewater. In various embodiments, the method includes providing a bioremediation system according to embodiments of bioremediation systems herein. In certain embodiments of methods herein, the bioremediation system includes:

a system wastewater inlet, a system wastewater outlet, an anaerobic reaction vessel, and an aerobic reaction vessel connected by at least one wastewater flow path;

wherein the anaerobic reaction vessel contains an anaerobic reaction solution,

wherein the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater, increasing an anaerobic pH of the anaerobic wastewater, or reducing an anaerobic concentration of organic compounds in the anaerobic wastewater, or a combination thereof; and

wherein the aerobic reaction vessel contains an aerobic reaction solution, wherein the aerobic reaction solution contains an aerobic concentration of at least one aerobic microorganism in an aerobic wastewater, wherein the at least one aerobic microorganism contains a metalloprotein, or is capable of reducing an aerobic concentration of CO2, or is capable of decreasing an aerobic concentration of metal from the aerobic wastewater, or a combination thereof.

In certain embodiments, the one or more heavy metals includes aluminum, iron, zinc, copper, lead, nickel, cadmium, chromium, titanium, vanadium, manganese, cobalt, gallium, germanium, arsenic, zirconium, niobium, and combinations thereof.

In various embodiments of methods herein, provided the wastewater entering the anaerobic reaction vessel includes one or more heavy metals, the method includes producing a sulfide by reacting the at least one anaerobic microorganism with a sulfate compound, and forming at least one metal sulfide compound by reacting one or more of the heavy metals with the sulfide. In certain embodiments, provided the wastewater entering the aerobic reaction vessel includes one or more heavy metals, the method includes reacting the one or more heavy metals with the at least one aerobic microorganism.

In certain embodiments, the method further includes measuring a pH level of wastewater entering the system wastewater inlet. Provided that the pH level ranges from about 4 or lower, the method includes flowing the wastewater from the system inlet into an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source, and the electrochemical reaction solution contains sodium chloride, sodium hydroxide, and sodium carbonate; and raising the pH level of the electrochemical reaction solution by forming sodium hydroxide and sodium bicarbonate. In other embodiments, provided that the pH level ranges from about 4.1 to 8.0, the method includes flowing wastewater from the system inlet to the anaerobic reaction vessel, the aerobic reaction vessel, or any combination thereof. In certain embodiments, the method includes forming sodium hydroxide and sodium bicarbonate by applying from about 0.7 Volts to about 10 Volts, or a current of from about 60 mA to about 100 mA, across the anode and the cathode in the presence of sodium chloride and carbon dioxide.

In certain embodiments, the method further includes forming a biomass in the aerobic reaction vessel, and feeding an amount of the biomass into the anaerobic reaction vessel. In certain embodiments, the method further includes collecting an amount of biomass from the aerobic reaction vessel. In certain embodiments, the anaerobic reaction vessel includes a nutrient inlet, and the method includes adding an amount of carbon dioxide, an amount of methane, or a combination thereof through the nutrient inlet.

In certain embodiments, the method further includes feeding the wastewater into the anaerobic reaction vessel at a flow rate of from about 50 liters/hour to about 150 liters/hour or more. In certain embodiments, the method includes flowing the wastewater through the anaerobic reaction vessel for a residence time of from about 2 hours to about 9 hours. In certain embodiments, the method includes feeding an anaerobic reaction vessel effluent into the aerobic reaction vessel at a flow rate of from about 50 liters/hour to about 150 liters/hour or more. In certain embodiments, the method includes flowing the wastewater through the aerobic reaction vessel for a residence time of from about 2 hours to about 9 hours.

In certain embodiments, provided the anaerobic wastewater in the anaerobic reaction vessel includes an anaerobic concentration one or more heavy metals, the method includes reducing the concentration of the one or more heavy metals in the wastewater by from about 1% to about 30% or more, based on the anaerobic concentration. In certain embodiments, provided the aerobic wastewater in the aerobic reaction vessel includes an aerobic concentration one or more heavy metals, the method includes reducing the concentration of the one or more heavy metals in the wastewater by from about 1% to about 30% or more, based on the aerobic concentration. In certain embodiments, provided that wastewater leaving the aerobic reaction vessel, the anaerobic reaction vessel, or the system wastewater outlet has a heavy metal content of 0.1 mg/l or more, the method includes flowing the wastewater to the aerobic reaction vessel, the anaerobic reaction vessel, or any combination thereof.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. Unless otherwise noted, the drawings are not to scale.

FIG. 1 is an illustration depicting a bioremediation system according to certain exemplary embodiments herein.

FIG. 2 is an illustration depicting a bioremediation system according to certain exemplary embodiments herein.

FIG. 3A is a graph showing optical density (OD) versus time for a culture of Spirulina platensis.

FIG. 3B is a graph showing pH versus time for a culture of Spirulina platensis.

FIG. 3C is a graph showing initial and final percentages of heavy metals in wastewater samples after 3 days of treatment using a culture of Spirulina platensis, according to an embodiment of methods herein.

FIG. 4A is a graph showing optical density (OD) versus time for a culture of sulfate-reducing bacteria Desulfovibrio vulgaris.

FIG. 4B is a graph showing pH versus time for a culture of sulfate-reducing bacteria Desulfovibrio vulgaris.

FIG. 5 is a graph showing optical density (OD) and pH versus time for a culture of Spirulina platensis grown on medium containing carbonate produced from electrochemical reactions.

FIG. 6 is a flow chart depicting an embodiment of a method of treating wastewater herein.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “pH meter connected to at least one of the system wastewater inlet, the system wastewater outlet, the electrochemical wastewater inlet, the electrochemical wastewater outlet, the aerobic wastewater inlet, or the aerobic wastewater inlet, or a combination thereof” means that the subject, pH meter, can be connected to one of objects listed (ex. the system wastewater inlet), more than one of the object listed (ex. two or more system wastewater inlets), or a connected to a combination of the objects listed (ex. 2 system wastewater inlets and 1 system wastewater outlet).

Unless otherwise noted, the term “about” refers to ±10% of the non-percentage number that is described, rounded to the nearest whole integer. For example, about 100 mA, would include 90 to 110 mA. Unless otherwise noted, the term “about” refers to ±5% of a percentage number. For example, about 30% would include 25 to 35%. When the term “about” is discussed in terms of a range, then the term refers to the appropriate amount less than the lower limit and more than the upper limit. For example, from about 50 liters/hour to about 150 liters/hour would include from 45 to 165 liters/hour.

Unless otherwise noted, properties (height, width, length, ratio etc.) as described herein are understood to be averaged measurements.

Unless otherwise noted, the terms “provide”, “provided” or “providing” refer to the supply, production, purchase, manufacture, assembly, formation, selection, configuration, conversion, introduction, addition, or incorporation of any element, amount, component, reagent, quantity, measurement, or analysis of any method or system of any embodiment herein.

Unless otherwise noted, the terms “heavy metal” or “heavy metals” refers to metals found in the 3 to 7 row of the periodic table.

Unless otherwise noted, a regular script number in a chemical formula can be a subscript. For example, CO2 is used interchangeably with CO₂, and K2HPO4 can be used interchangeably with K₂HPO₄.

Wastewater from industrial activities can contain various organic and inorganic contaminants. Among the most dangerous of these contaminants is heavy metals. Heavy metal pollution presents a serious environmental concern due to the toxicity of heavy metals, and their ability to accumulate in the tissues of living organisms, including plants and animals that are part of the global food chain. Wastewater can also be highly acidic, so that treatment to raise the pH level is also required before the wastewater can be safely discharged into the environment.

Several technologies have been applied to remove heavy metals from environmental wastewater, and to raise the pH levels for wastewater that is too acidic. Common remediation approaches can be classified into three main categories, including physical, chemical, and biological methods. Conventional technologies for the treatment of wastewater include various physicochemical methods, the addition of lime being the most traditional, which are generally expensive and involve an excessive use of chemicals. Biological remediation methods, or “bioremediation”, has emerged as a sustainable and promising alternative to conventional physical or chemical remediation methods. Bioremediation processes can involve the use of microorganisms such as bacteria, cyanobacteria or plants to remove, stabilize or precipitate contaminants from the environment, and also to raise pH levels.

Bioremediation approaches utilizing photosynthetic microorganisms for the treatment of wastewater have received increased attention recently. Such treatments can have advantages of competitive costs compared to most physical-chemical approaches, and more importantly, bioremediation has the demonstrated capability to capture CO2, thus contributing to sustainability with a lower carbon footprint. Photosynthetic microorganisms can be capable of bio-absorption and intracellular accumulation of heavy metals, which they can accomplish by specialized ion channels or transporters, or metal-binding proteins. Sulfate-reducing bacteria are also capable of providing a substantial removal of heavy metals from wastewater, as well as raising the pH levels as a result of their metabolism. Sulfate-reducing bacteria can be capable bio-adsorption, in which heavy metal contaminants bind to negatively charged groups on the cell surface, causing complexes of cells and heavy metals to fall out of solution. Extracellular polysaccharides play a critical role in these processes. However, compared to photosynthetic microorganisms, sulfate-reducing bacteria require a continuous supply of organic carbon as an electron donor for their growth, leading to additional operational complexities and costs for the use of these bacteria for wastewater treatment.

Interestingly, although bioremediation has been established over the years as a cost-effective treatment for contaminated soils and groundwater, the same trend has not been observed for the mining industry. This could be explained, in part, by the recurring uncertainties around bioremediation of acid mining drainage (AMD), together with existing skepticism associated with previous failures or undesirable results. Most, if not all, bioremediation failures are indeed associated with the poor understanding of microorganisms and mechanisms to maintain their efficiency for extended periods under different environmental conditions. It is known that the generation of sludge from biological treatment of AMD approaches may lead to a secondary form of pollution as waste that needs further treatment, and that is accompanied by additional costs. The development of an appropriate bioremediation strategy for AMD effluents requires knowledge of the desired microbiological factors and their nutrient requirements.

The need for bioremediation technologies that can provide for improved removal of heavy metals from wastewater such as acid mine drainage (AMD) is particularly relevant with regard to genetic modification. Genetic engineering has resulted in the identification of specific microbial genes that are responsible for producing metal chelating proteins, thus potentially enhancing a metal chelating capability in microbial strains. With advancements made in the field of synthetic biology, it is now possible to develop and engineer microorganisms to facilitate heavy metal removal from waste streams. It has been shown that Synechococcus elongatus expresses class II-metallothionein proteins involved with the absorption of heavy metals, such as copper(II), lead(II), nickel(II), cadmium(II), chromium(III), and chromium(VI) by the Cyanobacteria. Therefore, bioremediation of heavy metals could be enhanced by engineering the over production of metallothioneins in cyanobacteria. Nonetheless, these bacteria may not be able to thrive in effluents with very low pH or high concentrations of heavy metals that may be toxic or inhibitory to cell metabolism. There is a need for technologies using synthetic biology to surpass the natural metabolic capacity of native microorganisms, so that these recombinant organisms have the ability to perform faster and better in bioremediation technologies for wastewater treatment.

The use of chlor-alkali electrolysis for the production of NaOH (i.e., caustic soda) is a well-known and established technology that can provide a less expensive and more environmentally friendly alternative to lime treatment. Formation of NaOH helps in the removal of metals from aqueous solutions by precipitation of metals as carbonate complexes, while maintaining a pH level within an optimum range. While sodium bicarbonate may not be as efficient in removing metals from solution as some other bases, it does a great job in neutralizing excess acidity, which can help to achieve a wastewater pH that meets regulatory discharge standards. Two different mechanisms contribute to metal precipitation. First, metal speciation takes place during interaction with bicarbonate to form metal-bicarbonate complexes. During this process, the solubility of bicarbonate decreases (which is already much lower than that of NaOH), and so precipitation is quickly observed. Second, the formation of precipitates (sludge) can also strongly attract and bond dissolved metals, further assisting heavy metal removal. However, there remains a need for greater efficiency in treatments to remove heavy metals from wastewater, while even further helping to reduce the carbon footprint. Another downside of electrochemical reactions is the production of undesirable byproducts, such as oxidizing hypochlorite.

There are still challenges that need to be addressed for the successful application of bioremediation for wastewater treatment on an industrial field scale. For example, microorganisms used in bioremediation can be very susceptible to variations in environmental conditions, and changes in the physical and chemical characteristics of wastewater effluents. Low efficiency in remediation processes may be encountered as a result, if not complete failure of the treatment system. It is of key importance that microorganisms are selected that represent the most appropriate candidate microorganisms that have the capability to thrive site-specific conditions, such as weather and water physical-chemical composition. There is a need for technologies that can help to overcome such limitations, allowing for more robust and highly efficient wastewater treatment.

Embodiments of the present disclosure can provide a benefit of not only removing heavy metals from wastewater in a robust, efficient, and cost effective manner, but can also provide a benefit of utilizing CO2 as a carbon source for microbial growth, as well as for the production of valuable biomass, thus reducing excess CO2 from the environment. Such embodiments can also provide a benefit of raising the pH of acidic wastewater to environmentally acceptable levels. Embodiments herein can also provide a benefit of wastewater treatment for pH adjustment and removal of heavy metals on an industrial scale.

Embodiments herein can provide benefits of combinations of electrochemistry and biological approaches, including combinations of anaerobic and aerobic microbial cultures, as low energy cost and eco-friendly alternative treatments to remove heavy metals from wastewater, and to neutralize pH from wastewater streams. Embodied systems and methods herein can utilize carbon dioxide as a value-added product of fossil-fueled power plants, rather than a production-limiting waste product. In this way, the carbon originally released from industrial activities can be captured and recycled in a closed-loop system, thus significantly lowering the overall carbon emissions and footprint. Embodiments herein can provide electrochemical and biological carbon capture and conversion systems and methods to remove carbon dioxide from the atmosphere from industrial emissions.

Embodiments herein can have a benefit of enhancing economic and energy security through providing technologies that can reduce energy-related emissions of greenhouse gases. The impacts of embodiments herein may provide mining companies with an environmentally responsible and economically viable carbon capture system during remediation or rehabilitation of their waste streams. Furthermore, the utilization of embodiments herein can create new green jobs associated with the design, construction, maintenance and operation of embodied systems herein at mining and related industries across the country, as well as spur increased activity and innovation in the bioremediation processing industries focused on utilizing the biomass that can be produced.

### Bioremediation Systems of Embodiments Herein

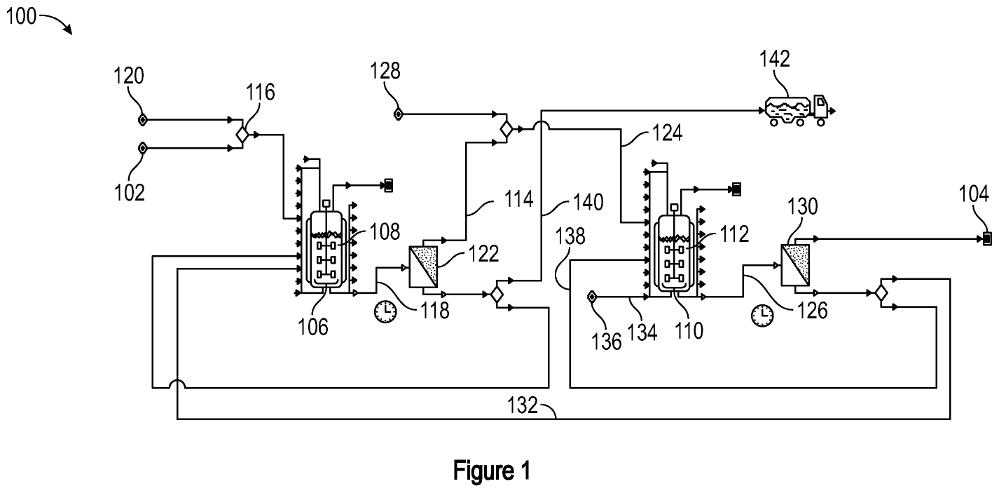

The present disclosure relates to bioremediation systems for wastewater treatment. As an illustration of a system disclosed herein, referring to FIG. 1, system 100 includes wastewater inlet 102, wastewater outlet 104, anaerobic reaction vessel 106 containing anaerobic reaction solution 108, and aerobic reaction vessel 110 containing aerobic reaction solution 112, connected by at least one wastewater flow path 114; anaerobic wastewater inlet 116, anaerobic wastewater outlet 118, anaerobic nutrient inlet 120, and anaerobic biomass outlet 122 connected with anaerobic reaction vessel 106; aerobic wastewater inlet 124, aerobic wastewater outlet 126, aerobic nutrient inlet 128, and aerobic biomass outlet 130 connected with aerobic reaction vessel 110; aerobic biomass fluid flow path 132 connects aerobic reaction vessel 110 and anaerobic vessel 106; gas influent flow path 134 connects aerobic reaction vessel 110 with carbon dioxide source 136; wastewater fluid path 138 connects aerobic biomass outlet 130 with aerobic reaction vessel 110; anaerobic biomass collection port 140 connects anaerobic biomass outlet 122 with vehicle 142.

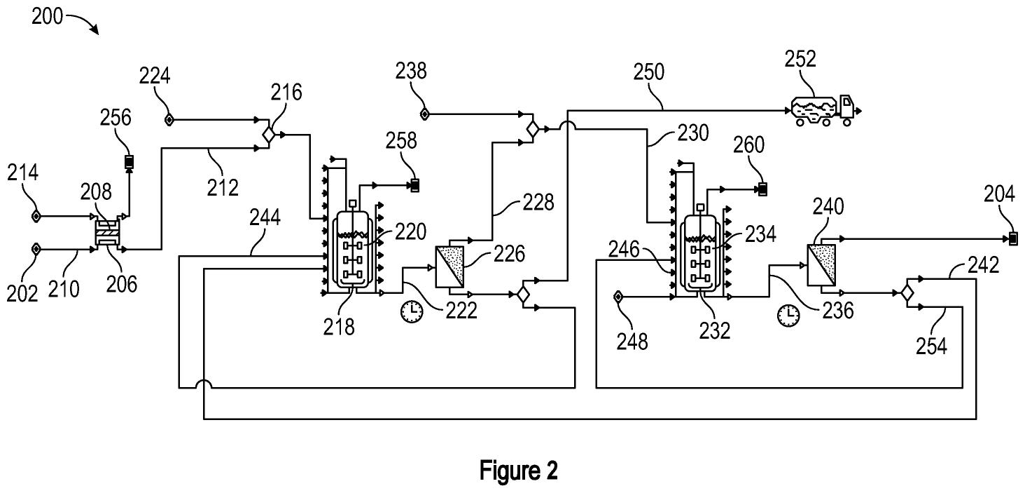

As an illustration of a system disclosed herein, referring to FIG. 2, system 200 includes wastewater inlet 202, wastewater outlet 204, electrochemical reaction vessel 206 containing electrochemical reaction solution 208, electrochemical wastewater inlet 210, electrochemical wastewater outlet 212, and carbon dioxide source 214; wastewater flow path 216 connecting electrochemical reaction vessel 206 to anaerobic reaction vessel 218 containing anaerobic reaction solution 220; anaerobic wastewater outlet 222, anaerobic nutrient inlet 224, and anaerobic biomass outlet 226 are connected to anaerobic reaction vessel 218; fluid flow path 228 connecting anaerobic wastewater outlet 222 and aerobic wastewater inlet 230 connected to aerobic reaction vessel 232 containing aerobic reaction solution 234; aerobic wastewater outlet 236, aerobic nutrient inlet 238, and aerobic biomass outlet 240 are connected to aerobic reaction vessel 232; wastewater fluid path 242 connects aerobic reaction vessel 232 and anaerobic reaction vessel 218; wastewater flow path 244 connects anaerobic biomass outlet 226 with anaerobic reaction vessel 218; gas flow path 246 connects aerobic reaction vessel 232 with aerobic carbon dioxide source 248; anaerobic biomass collection port 250 connects anaerobic biomass outlet 226 with vehicle 252. Wastewater fluid path 254 connects aerobic biomass outlet 240 and aerobic reaction vessel 232. Vents 256, 258 and 260 are connected with electrochemical reaction vessel 206, anaerobic reaction vessel 218, and aerobic reaction vessel 232 respectively.

Embodiments herein are directed to bioremediation systems for wastewater treatment. In various embodiments, the system includes a system wastewater inlet, a system wastewater outlet, an anaerobic reaction vessel, and an aerobic reaction vessel connected by at least one wastewater flow path. In various embodiments, the anaerobic reaction vessel contains an anaerobic reaction solution, wherein the anaerobic reaction solution contains an anaerobic concentration of at least one anaerobic microorganism in an anaerobic wastewater. In various embodiments, the at least one anaerobic microorganism is capable of reducing an anaerobic concentration of metal in the anaerobic wastewater, is capable of increasing an anaerobic pH of the anaerobic wastewater, is capable of reducing an anaerobic concentration of organic compounds in the anaerobic wastewater, or a combination thereof. In various embodiments, the aerobic reaction vessel contains an aerobic reaction solution, wherein the aerobic reaction solution contains an aerobic concentration of at least one aerobic microorganism in an aerobic wastewater. In various embodiments, the at least one aerobic microorganism contains a metalloprotein, is capable of reducing an aerobic concentration of CO2, is capable of decreasing an aerobic concentration of metal from the aerobic wastewater, or a combination thereof.

Embodiments herein can integrate anaerobic and aerobic bioremediation reactions in the same bioremediation system. Reaction vessels of embodiments herein can be built in modules connected in series, or in different arrangements to best suit wastewater treatment efficiency and remediation goals. In certain embodiments, an aerobic reaction vessel can be placed downstream of the anaerobic reaction vessel, and operate under aerobic culture conditions including at least one aerobic microorganism. In such embodiments, the flow path connecting the anaerobic reaction vessel and the aerobic reaction vessel can enable the flow of wastewater for further treatment, or for the flow of anaerobic biomass, and nutrients from the anaerobic reaction vessel to the aerobic reaction vessel. Such embodiments can provide a benefit of enhancement of the wastewater treatment, or a benefit of augmenting the growth of the at least one aerobic microorganism, thus improving the bioremediation performance of the system.

In certain embodiments, the anaerobic reaction vessel further includes an anaerobic wastewater inlet, an anaerobic wastewater outlet, an anaerobic nutrient inlet, and an anaerobic biomass outlet. In such embodiments, the anaerobic wastewater inlet can be connected to a wastewater source to allow the flow of wastewater directly into the anaerobic reaction vessel. For example, if the pH of water was found to be within acceptable parameters, then the wastewater can be directed toward the anaerobic wastewater inlet for immediate metal remediation. In some embodiments, the anaerobic nutrient inlet can be connected to an anaerobic nutrient source to augment the growth of the at least one anaerobic microorganism; in certain embodiments, the anaerobic nutrient source can include a carbon dioxide source. Such embodiments can provide a benefit of enhancing the wastewater treatment efficiency while utilizing carbon dioxide. In such embodiments, the anaerobic biomass outlet can provide a benefit of enabling the collection of anaerobic biomass from the anaerobic reaction vessel, for disposal, the recycling of heavy metals from the anaerobic biomass, or other purposes.

In certain embodiments, the aerobic reaction vessel further includes an aerobic wastewater inlet, an aerobic wastewater outlet, an aerobic nutrient inlet, and an aerobic biomass outlet. In such embodiments, the aerobic wastewater inlet can be connected to a wastewater source to allow the flow of wastewater directly into the aerobic reaction vessel. In such embodiments, the aerobic nutrient inlet can be connected to an aerobic nutrient source to augment the growth of the at least one aerobic microorganism; in certain embodiments, the aerobic nutrient source can include a carbon dioxide source. Such embodiments can provide a benefit of enhancing the wastewater treatment efficiency while utilizing carbon dioxide. In such embodiments, the aerobic biomass outlet can provide a benefit of enabling the collection of aerobic biomass from the aerobic reaction vessel, for disposal, the recycling of heavy metals from the aerobic biomass, or other purposes.

In certain embodiments, the system includes at least one wastewater fluid path connecting the anaerobic wastewater inlet to the aerobic wastewater outlet. Such embodiments can provide a benefit of the flow of wastewater from the aerobic reaction vessel to the anaerobic reaction vessel, thus providing for further treatment of the wastewater. In certain embodiments, the bioremediation system further includes an aerobic biomass fluid flow path connecting the aerobic reaction vessel and the anaerobic reaction vessel. Such embodiments can provide a benefit of the flow of biomass and other nutrients from the aerobic reaction vessel to the anaerobic reaction vessel. In such embodiments, a surplus of biomass generated from the aerobic reaction vessel may be collected and utilized as a carbon source to feed and maintain the at least one anaerobic microorganism in the anaerobic reaction vessel, thus providing a benefit of enhancing the performance of the wastewater treatment. In other embodiments, the collected aerobic biomass can be processed as fertilizer, feedstock, or biofuel, thus providing a benefit of not only the treatment of wastewater, but the production of one or more useful products.

In certain embodiments, the anaerobic reaction vessel and the aerobic reaction vessel each independently includes a vessel wall. Such a vessel wall may include a vessel wall of a bioreactor vessel. In certain embodiment, the vessel wall includes a cement material, a fiberglass material, a fiber material, a steel material, a natural formation, a pre-treated natural formation, a plastic material, a gel material, or a combination thereof. In an embodiment, a pre-treated natural formation can include adding a dam to an outlet to control water levels or treating at least a portion of the natural formation with a material to prevent or reduce seepage into ground water. For example, a portion of the natural formation can be sprayed with wax, tar, or paint to prevent or reduce water loss from the vessel. In an embodiment, the vessel wall excludes natural formations.

In certain embodiments, the anaerobic reaction vessel, the aerobic reaction vessel, or any combination thereof, has a volume of from about 1000 liters to about 1 million liters. In certain embodiments, the anaerobic reaction vessel, the aerobic reaction vessel, or any combination thereof, has a volume of from about 200,000 liters to about 800,000 liters. In certain embodiments, the anaerobic reaction vessel, the aerobic reaction vessel, or any combination thereof, has a volume of from about 500,000 liters to about 700,000 liters. A benefit of such volumes can be economy of scale for bioremediation. In certain embodiments, the anaerobic concentration ranges from about 10⁷ to about 10⁹ cells per milliliter, or an optical density of about 0.6 to about 1.0. In certain embodiments, the anaerobic concentration ranges from about 10^{7.5} to about 10^{8.5} cells per milliliter, or an optical density of about 0.7 to about 0.9. In certain embodiments, the anaerobic concentration ranges from about 10^{7.7} to about 10⁸ cells per milliliter, or an optical density of about 0.75 to about 0.85. In certain embodiments, the aerobic concentration ranges from about 10⁷ to about 10⁹ cells per milliliter, or an optical density of about 0.6 to about 1.0. In certain embodiments, the aerobic concentration ranges from about 10^{7.5} to about 10^{8.5} cells per milliliter, or an optical density of about 0.7 to about 0.9. In certain embodiments, the aerobic concentration ranges from about 10^{7.7} to about 10⁸ cells per milliliter, or an optical density of about 0.75 to about 0.85. A benefit of such concentrations and optical densities can be the formation of healthy, active biomass forming cultures of microorganisms for bioremediation. When the concentration or optical density falls below these ranges, then efficiency is lost because the biomass is too small. When the concentration or optical density goes above these ranges, then efficiency is not significantly improved as microorganisms have used up all resources for maintenance of their metabolism.

In certain embodiments, the bioremediation system further includes an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source. In certain embodiments, the cathode, the anode, or a combination thereof, includes graphite, graphene, zinc, copper, nickel, silver mesh electrodes, palladium, carbon nanosheets, boron doped diamond materials or films. In such embodiments, the electrochemical reaction vessel is connected by the at least one wastewater flow path to the anaerobic reaction vessel, the aerobic reaction vessel, or a combination thereof. Such embodiments can provide a benefit of integrating physical-chemical processes with anaerobic and aerobic biological reactions. In such embodiments, electrochemical reaction vessels, anaerobic reaction vessels, and aerobic reaction vessels can be built in modules connected in series, and in different arrangements to better suit treatment efficiency and bioremediation goals. Electrochemical reaction vessel embodiments herein can be used as an optional modular treatment unit in a first stage in a system to increase the pH of acidic wastewater, including for minor polishing of water samples in situations where the pH is too low (pH 1 to 3 or less) to sustain biological activity, or to remove or reduce concentrations of heavy metals present at very high concentrations, which can be toxic to microorganisms and potentially inhibitory to bioremediation. In such embodiments, electrochemistry can provide a benefit of a preliminary treatment to alleviate these inhibitory parameters for successful bioremediation down-gradients in the treatment train.

In embodiments herein, carbonates generated by the electrochemical reaction vessel may be used in the anaerobic reaction vessel, the aerobic reaction vessel, or a combination thereof placed downstream in the treatment train, as a source of substrate nutrient for the at least one anaerobic microorganism or the at least one aerobic microorganism. Also, by conversion of CO₂ to bicarbonate, embodiments of the electrochemical reaction vessel can provide a benefit of an additional source or carbon for the microorganisms, thus stimulating cell growth.

In certain embodiments, the electrochemical reaction vessel can include a water tank, a pond, a manmade retention pond, a natural formation, synthetic formation, or other container of a suitable size. In such embodiments, the electrochemical reaction vessel can include a vessel wall. In certain embodiments, the vessel wall includes a cement material, a fiberglass material, a fiber material, a steel material, a natural formation, a pre-treated natural formation, a plastic material, a gel material, or a combination thereof. In embodiments that include a natural formation, the natural formation can be lined with one or more vessel wall materials, including but not limited to a plastic material or a thin plastic material. In an embodiment, a pre-treated natural formation can include adding a dam to an outlet to control water levels or treating at least a portion of the natural formation with a material to prevent or reduce seepage into ground water. For example, a portion of the natural formation can be sprayed with wax, tar, or paint to prevent or reduce water loss from the vessel. In an embodiment, the vessel wall excludes natural formations.

In certain embodiments, the electrochemical reaction vessel contains an electrochemical reaction buffer, wherein the electrochemical reaction buffer includes an amount of sodium chloride, sodium hydroxide, sodium carbonate, calcium carbonate, potassium carbonate, potassium chloride, potassium hydroxide, magnesium chloride, or a combination thereof. In certain embodiments, the electrochemical reaction vessel includes a chlor-alkali electrochemical cell. In such embodiments, the formation of NaOH can provide a benefit of causing the precipitation of metals out of solution by precipitation as carbonate complexes, while helping to achieve a desired pH level for acidic wastewater.

In certain embodiments, the carbon dioxide source includes a carbon dioxide inlet. In such embodiments, the carbon dioxide inlet can be connected to a carbon dioxide source. Such embodiments can provide benefits of utilizing carbon dioxide, while raising the pH level of acidic wastewater, and also providing carbonates as a carbon source for the growth of the anaerobic microbial and/or aerobic microbial cultures.

In certain embodiments, the power source includes sunlight, a solar power source, an electrical power source, or a combination thereof. In certain embodiments, the power source is configured to provide a voltage of from about 0.7 Volts to about 10 Volts, or a current of from about 60 mA to about 100 mA. In certain embodiments, the power source is configured to provide a voltage of from about 1.0 Volts to about 8.0 Volts, or a current of from about 70 mA to about 90 mA. In certain embodiments, the power source is configured to provide a voltage of from about 3.0 Volts to about 5.0 Volts, or a current of from about 75 mA to about 85 mA.

In certain embodiments, the electrochemical reaction vessel has a volume of from about 1,000 liters to about 1 million liters. In certain embodiments, the electrochemical reaction vessel has a volume of from about 200,000 liters to about 800,000 liters. In certain embodiments, the electrochemical reaction vessel has a volume of from about 500,000 liters to about 700,000 liters. A benefit of such volumes can be economy of scale for this bioremediation process.

In certain embodiments, the electrochemical reaction vessel, the anaerobic reaction vessel, and the aerobic reaction vessel each independently includes a vessel wall, wherein the vessel wall includes a cement material, a fiberglass material, a fiber material, a steel material, a natural formation, a plastic material, a gel material, or a combination thereof.

In certain embodiments of a bioremediation system, the anaerobic reaction vessel and the aerobic reaction vessel include a sample port, an optical density reader, a turbidity reader, or a combination thereof. In certain embodiments, the bioremediation system further includes a pH meter connected to at least one of the system wastewater inlet, the system wastewater outlet, the electrochemical wastewater inlet, the electrochemical wastewater outlet, the aerobic wastewater inlet, the aerobic wastewater inlet, or a combination thereof. In certain embodiments, the bioremediation system further includes a heavy metal detector connected to at least one of the system wastewater inlet, the system wastewater outlet, the electrochemical wastewater outlet, the aerobic wastewater inlet, the aerobic wastewater inlet, or a combination thereof. Such embodiments can provide a benefit of an ability to measure and monitor the optical density, turbidity, or other characteristic of the anaerobic reaction solution or the aerobic reaction solution. Such embodiments can provide a benefit of an ability to measure and monitor the pH or heavy metal content of the wastewater at the various locations of inlet or outlet of wastewater in the bioremediation system. Such embodiments can provide a benefit of providing real-time or near real-time pH and/or heavy metal concentrations measurements, which can allow for wastewater to be routed into the reaction vessels suited for treating treat low pH or reducing high heavy metal concentrations, or recycled back into one or more reaction vessels for increased residence time. These measurements can prevent or reduce shocks from excessively high pH or high heavy metal concentrations that might disrupt microorganism concentrations. These measurements can allow for a “smart system” that ensures that water having an excessively high pH or metal content is not accidently released into the environment as treated wastewater. These measurements can allow for the processing a volume of wastewater to be routed through a combination of reaction vessels for optimal efficiency.

In some embodiments of a bioremediation system, the electrochemical reaction vessel, the anaerobic reaction vessel, the aerobic reaction vessel, or any combination thereof, is mounted on or among one or more vehicles. In certain embodiments, the electrochemical reaction vessel, the anaerobic reaction vessel, the aerobic reaction vessel, or any combination thereof, is located within 0.3 kilometers of an industrial site and connected to the industrial site by a gas flow path from the industrial site to the carbon dioxide source, or a wastewater flow path from the industrial site to the system wastewater inlet, or a combination thereof. In certain embodiments, the aerobic reaction vessel further comprises a gas flow path connected to the carbon dioxide source, a gas flow path connected to an air source, or a combination thereof. Such embodiments can provide a benefit of the transport of one or more reaction vessels of various embodiments to a site where wastewater is to be treated. Other embodiments can provide benefits of enabling wastewater to be treated using embodiments of systems that can be located at the site of treatment of the wastewater, or located within a distance from the industrial site or the location of the wastewater to be treated, or enabling use of embodied systems at or near the location of a carbon dioxide source.

### Anaerobic Reaction Cultures of Various Embodiments

In various embodiments of bioremediation systems herein, the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater. In certain embodiments, the at least one anaerobic microorganism is capable of increasing an anaerobic pH of the anaerobic wastewater. In certain embodiments, the at least one anaerobic microorganism is capable of reducing an anaerobic concentration of organic compounds in the anaerobic wastewater.

In certain embodiments of a bioremediation system, the at least one anaerobic microorganism is capable of reducing a concentration of sulfate and increasing a concentration of sulfide in the anaerobic wastewater. In such embodiments, the anaerobic reaction vessel operates under anaerobic conditions, and the at least one anaerobic microorganism includes at least one sulfate-reducing microorganism. In certain embodiments, the at least one anaerobic microorganism includes at least one sulfate-reducing bacteria. Sulfate-reducing bacteria (SRB) can facilitate the conversion of sulfate to sulfide. The interaction of sulfides with heavy metals leads to the precipitation of toxic metals in the form of metal sulfides, which are stable and can be removed from the effluents. SRB can provide a benefit of the simultaneous removal of both metals and sulfates, which does not occur with traditional chemical processes. Such embodiments can provide a benefit of removing heavy metals from the anaerobic wastewater in the form of metal precipitation. Such embodiments can also provide a benefit of reduction of heavy metals through the adsorption of heavy metals by the at least one sulfate-reducing microorganism, and precipitation of complexes of the microorganisms and heavy metals from solution as sludge.

In certain embodiments, the at least one anaerobic microorganism is capable of increasing an anaerobic pH of the anaerobic wastewater. In certain embodiments, the at least one anaerobic microorganism includes at least one sulfate-reducing microorganism, which in various embodiments can be selected for a capability of effective removal of heavy metals from contaminated wastewater, while having a capability of increasing the pH of acidic wastewater. In certain embodiments, the at least one sulfate-reducing microorganism can be selected to remove heavy metals and increase the pH of acidic effluents from acid mine drainage (AMD). In such embodiments, the at least one sulfate-reducing microorganism can be selected based on a criterion of a metabolic capacity to stabilize, precipitate, or absorb heavy metal residues from the environment, or a criterion of a high tolerance to survive in a toxic environmental condition, including conditions of a high concentration of heavy metals and a low pH.

In certain embodiments, the at least one anaerobic microorganism is capable of oxidizing the anaerobic concentration of organic compounds in the anaerobic wastewater. In certain embodiments, the organic compounds include carbohydrates, organic acids including but not limited to formate, lactate, acetate, propionate, and butyrate; alcohols including but not limited to methanol and ethanol; aliphatic hydrocarbons including but not limited to methane; aromatic hydrocarbons including but not limited to benzene, toluene, ethylbenzene, and xylene; molecular hydrogen, and combinations thereof. In certain embodiments, the at least one anaerobic microorganism is capable of producing sulfide. In certain embodiments, the at least one anaerobic microorganism is capable of assimilatory reduction of a sulfate. In certain embodiments, the at least one anaerobic microorganism is capable of reducing an oxidized inorganic sulfur compound. In certain embodiments, the oxidized sulfur compound includes sulfite, dithionite, thiosulfate, trithionate, tetrathionate, elemental sulfur, polysulfides, and combinations thereof.

In certain embodiments, the at least one anaerobic microorganism includes a microorganism selected from the group consisting of Desulfovibrio desulfuricans, Desulfovibrio vulgaris, Desulfovibrio gigas, Caldivirga maquilingensis, Desulfatibacillum alkenivorans, Desulfotomaculum nigrificans, Desulfococcus multivorans, Thermodesulfovibrio yellowstonii, Desulfovibrio aespoeensis, Desulfovibrio aerotolerans, Desulfovibrio fructosivorans, Desulfococcus oleovorans, Desulfovibrio aminophilus, Desulfovibrio ferrireducens, Desulfovibrio salexigens, Desulfovibrio africanus, Archaeoglobus fulgidus, Desulfococcus biacutus, Desulfatibacillum aliphaticivorans, Desulfatirhabdium butyrativorans, Desulfofaba gelida, Desulfovibrio capillatus, Desulfosporomusa spp., Desulfovibrio acrylicus, Desulfovibrio legallii, Desulfosarcina alkanivorans, Desulfatiferula berrensis, Desulfobacula toluolica, Desulfovibrio frigidus, Desulfofaba hansenii, Desulfovibrio senezii, Desulfovibrio arcticus, Thermodesulfobium narugense, Desulfovibrio burkinensis, Thermodesulfobium acidiphilum, Thermocladium modestius, Caldimicrobium rimae, Desulfosarcina ovata, Thermodesulfobacterium hveragerdense, Desulfovibrio alcoholivorans, Desulfovibrio singaporenus, Caldimicrobium thiodismutans, Desulfosporosinus orientis, Desulfovibrio marinus, Desulfatitalea tepidiphila, Desulfofaba fastidiosa, Desulfovibrio ferrophilus, Desulfovibrio bizertensis, Desulfovibrio biadhensis, Desulfatiferula olefinivorans, Desulfobacula phenolica, Dehalococcoides spp., Geobacteria spp., Acetobacterium woodi, Clostridium ljungdahlii, Moorella thermoacethica, and methanotrophic bacteria, or a combination thereof.

### Aerobic Microorganisms of Various Embodiments

In various embodiments of bioremediation systems herein, the aerobic reaction vessel contains an aerobic reaction solution, wherein the aerobic reaction solution contains an aerobic concentration of at least one aerobic microorganism in an aerobic wastewater. In such embodiments, the anaerobic reaction vessel operates under aerobic conditions including a culture of the at least one aerobic microorganism, which in certain embodiments can include a photosynthetic microorganism. Such autotrophic microorganisms can utilize light, and a combination of one or more nutrients including nitrogen, phosphorus, and CO2 present in the atmosphere, or from a CO2 source, for their growth. In certain embodiments, the at least one aerobic microorganism is capable of reducing an aerobic concentration of CO2. Such embodiments can provide a benefit of utilization of CO2 for its reduction from the environment. In certain embodiments, an aerobic nutrient, which can include carbon dioxide, can enhance growth of the aerobic microbial culture, and thus can provide a benefit of a greater overall wastewater treatment efficiency. The growth of the aerobic microbial culture can also produce an aerobic biomass as a result of aerobic microbial metabolism, which in certain embodiments can be used to supply a carbon and nutrient source that can be used to augment the growth of the anaerobic microbial culture. Such embodiments can provide benefits of enhancing the efficiency of the bioremediation system, and increasing the removal of heavy metals from the wastewater, thus improving the overall wastewater treatment.

In certain embodiments, the at least one aerobic microorganism is capable of decreasing an aerobic concentration of metal from the aerobic wastewater. During the aerobic bioremediation process of various embodiments, as the heavy metals are absorbed, the pH of the aerobic wastewater increases as a result of the activity of the at least one aerobic microorganism. Such embodiments can provide a benefit of raising the pH of acidic wastewater to an environmentally acceptable level, while reducing the heavy metal concentration of the wastewater.

In certain embodiments, the at least one aerobic microorganism contains a metalloprotein. In such embodiments, the at least one aerobic microorganism can include an aerobic microorganism that naturally expresses a metalloprotein, a recombinant aerobic microorganism expressing an exogenous metalloprotein, or a combination thereof. Such an aerobic microorganisms can include an extremophile isolated from the environment, or artificially engineered in the laboratory using synthetic biology. In such embodiments, one or more genes involved in the expression of metalloproteins can be over expressed in the at least one recombinant aerobic microorganism. Such embodiments can provide benefits of increased metal absorption, and improved removal of heavy metals during wastewater treatment.

In certain embodiments, the at least one aerobic microorganism includes at least one recombinant aerobic microorganism that expresses at least one protein of at least one aerobic genetic pathway, wherein the at least one aerobic genetic pathway provides to the at least one aerobic microorganism one or more of a resistance to a high concentration of heavy metals, a resistance to a low pH level, a production of one or more of an alkaline organic molecule, sodium bicarbonate, ammonia, acetate, and an electron donor; and combinations thereof.

In various embodiments, the at least one aerobic microorganism can be selected based on several criteria, including but not limited to having broad metabolic capacities, including photosynthesis and heterotrophic growth with a variety of carbon sources, as well as the ability to grow under low pH conditions, and to withstand broad temperature ranges. In certain embodiments, the at least one aerobic microorganism can be selected based on having a high absorption capacity of minerals and heavy metals. In certain embodiments, the at least one aerobic microorganism includes a microorganism selected from the group consisting of an acidophilic microorganism, Galdieria sulphuraria, a bicarbonate producing species, an alkaline producing species, Spirulina platensis, a Cyanobacteria, Synechococcus elongatus, Synechocystis spp., and a recombinant aerobic microorganism that expresses a higher amount of at least one metalloprotein relative to a control aerobic microorganism.

### Methods of Treating Wastewater of Various Embodiments

Embodiments herein are directed to methods of treating wastewater. As an illustration of a method according to embodiments herein, referring to FIG. 6, the method includes: providing a bioremediation system 602, wherein the bioremediation system includes:

a system wastewater inlet, a system wastewater outlet, an anaerobic reaction vessel, and an aerobic reaction vessel connected by at least one wastewater flow path;

wherein the anaerobic reaction vessel contains an anaerobic reaction solution,

wherein the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater, increasing an anaerobic pH of the anaerobic wastewater, or reducing an anaerobic concentration of organic compounds in the anaerobic wastewater, or a combination thereof; and

wherein the aerobic reaction vessel contains an aerobic reaction solution, wherein the aerobic reaction solution contains an aerobic concentration of at least one aerobic microorganism in an aerobic wastewater, wherein the at least one aerobic microorganism contains a metalloprotein, or is capable of reducing an aerobic concentration of CO2, or is capable of decreasing an aerobic concentration of metal from the aerobic wastewater, or a combination thereof; measuring a pH level of wastewater entering the system wastewater inlet 604; provided that the pH level ranges from about 4 or lower, flowing the wastewater from the system inlet into an electrochemical reaction vessel 606, wherein the electrochemical reaction vessel includes an electrochemical reaction solution, an electrochemical wastewater inlet, an electrochemical wastewater outlet, an anode, a cathode, a power source, and a carbon dioxide source, and the electrochemical reaction solution contains sodium chloride, sodium hydroxide, and sodium carbonate; raising the pH level of the electrochemical reaction solution 608 by forming sodium hydroxide and sodium bicarbonate; or provided that the pH level ranges from about 4.1 to 8.0, flowing wastewater from the system inlet to the anaerobic reaction vessel, the aerobic reaction vessel, or any combination thereof 610; provided the wastewater entering the anaerobic reaction vessel includes one or more heavy metals, producing a sulfide 612 by reacting the at least one anaerobic microorganism with a sulfate compound, and forming at least one metal sulfide compound by reacting one or more of the heavy metals with the sulfide; and provided the wastewater entering the aerobic reaction vessel includes one or more heavy metals, reacting the one or more heavy metals with the at least one aerobic microorganism 614.

In various embodiments, the method includes providing a bioremediation system according to embodiments of bioremediation systems herein. In certain embodiments of methods herein, the bioremediation system includes:

a system wastewater inlet, a system wastewater outlet, an anaerobic reaction vessel, and an aerobic reaction vessel connected by at least one wastewater flow path;

wherein the anaerobic reaction vessel contains an anaerobic reaction solution,

wherein the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater, increasing an anaerobic pH of the anaerobic wastewater, or reducing an anaerobic concentration of organic compounds in the anaerobic wastewater, or a combination thereof; and

wherein the aerobic reaction vessel contains an aerobic reaction solution, wherein the aerobic reaction solution contains an aerobic concentration of at least one aerobic microorganism in an aerobic wastewater, wherein the at least one aerobic microorganism contains a metalloprotein, or is capable of reducing an aerobic concentration of CO2, or is capable of decreasing an aerobic concentration of metal from the aerobic wastewater, or a combination thereof.

In certain embodiments, the one or more heavy metals includes aluminum, iron, zinc, copper, lead, nickel, cadmium, chromium, titanium, vanadium, manganese, cobalt, gallium, germanium, arsenic, zirconium, niobium, and combinations thereof. In certain embodiments, the one or more heavy metals includes one or more heavy metals from rows 2-7 of the periodic table.

In various embodiments of methods herein, provided the wastewater entering the anaerobic reaction vessel includes one or more heavy metals, the method includes producing a sulfide by reacting the at least one anaerobic microorganism with a sulfate compound, and forming at least one metal sulfide compound by reacting one or more of the heavy metals with the sulfide. In certain embodiments, provided the wastewater entering the aerobic reaction vessel includes one or more heavy metals, the method includes reacting the one or more heavy metals with the at least one aerobic microorganism.

In certain embodiments, the method further includes measuring a pH level of wastewater entering the system wastewater inlet. Provided that the pH level ranges from about 4 or lower, the method includes flowing the wastewater from the system inlet into an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source, and the electrochemical reaction solution contains sodium chloride, sodium hydroxide, and sodium carbonate; and raising the pH level of the electrochemical reaction solution by forming sodium hydroxide and sodium bicarbonate. Such embodiments can provide a benefit of raising the pH level of acidic wastewater to a level that is suitable for the growth of the anaerobic microorganisms or the aerobic microorganisms. In certain embodiments, a source of CO2 can be used to react with hydrogen ions in a brine solution formed during the separation of water molecules via the utilization of the cathode and anode electrodes. An end product of the electrochemical reaction in such embodiments includes carbonates, which can provide benefits of raising the pH level of the wastewater and facilitating precipitation of metals, as well as generating carbonates that can serve as a nutrient substrate for microorganism growth in the reaction vessels downstream of the electrochemical reaction vessel.

In certain embodiments, the method includes forming sodium hydroxide and sodium bicarbonate by applying voltage of from about 0.7 Volts to about 10 Volts, or a current of from about 60 mA to about 100 mA, across the anode and the cathode in the presence of sodium chloride and carbon dioxide. In certain embodiments, the method includes forming sodium hydroxide and sodium bicarbonate by applying a voltage of from about 1.0 Volts to about 8.0 Volts, or a current of from about 70 mA to about 90 mA. In certain embodiments, the method includes forming sodium hydroxide and sodium bicarbonate by applying a voltage of from about 3.0 Volts to about 5.0 Volts, or a current of from about 75 mA to about 85 mA.

In certain embodiments, the anaerobic reaction vessel includes a nutrient inlet, and the method includes adding an amount of carbon dioxide, an amount of methane, or a combination thereof through the nutrient inlet. Such embodiments can provide a benefit of providing one or more nutrients directly to the anaerobic reaction vessel, in order to augment the growth of the at least one anaerobic microorganism, thus enhancing the performance of the bioremediation system.

In other embodiments, provided that the pH level ranges from about 4.1 to 8.0, the method includes flowing wastewater from the system inlet to the anaerobic reaction vessel, the aerobic reaction vessel, or any combination thereof. Such embodiments can provide a benefit of increasing the efficiency of wastewater treatment, by flowing wastewater that has a suitably high pH level directly into the anaerobic reaction vessel and/or the aerobic reaction vessel.

In certain embodiments, the method further includes forming a biomass in the aerobic reaction vessel, and feeding an amount of the biomass into the anaerobic reaction vessel. In certain embodiments, the method further includes collecting an amount of biomass from the aerobic reaction vessel. In such embodiments, a surplus of biomass generated from the aerobic reaction vessel may be collected and utilized as a carbon source to feed and maintain the at least one anaerobic microorganism in the anaerobic reaction vessel, thus providing a benefit of enhancing the performance of the wastewater treatment. In other embodiments, the collected aerobic biomass can be processed as fertilizer, feedstock, or biofuel, thus providing a benefit of not only the treatment of wastewater, but the production of one or more useful products. The collected biomass can also provide a benefit of allowing the recovery of heavy metals present in the biomass.

In certain embodiments, the method further includes feeding the wastewater into the anaerobic reaction vessel at a flow rate of from about 50 liters/hour to about 150 liters/hour or more. In certain embodiments, the method further includes feeding the wastewater into the anaerobic reaction vessel at a flow rate of from about 75 liters/hour to about 125 liters/hour or more. In certain embodiments, the method further includes feeding the wastewater into the anaerobic reaction vessel at a flow rate of from about 90 liters/hour to about 100 liters/hour or more. In certain embodiments, the method further includes feeding the wastewater into the anaerobic reaction vessel at a flow rate of up to 9,000 liters/day or more. In certain embodiments, the method includes flowing the wastewater through the anaerobic reaction vessel for a residence time of from about 2 hours to about 9 hours. In certain embodiments, the method includes flowing the wastewater through the anaerobic reaction vessel for a residence time of from about 3 hours to about 8 hours. In certain embodiments, the method includes flowing the wastewater through the anaerobic reaction vessel for a residence time of from about 4 hours to about 7 hours.

In certain embodiments, the method includes feeding an anaerobic reaction vessel effluent into the aerobic reaction vessel at a flow rate of from about 50 liters/hour to about 150 liters/hour or more. In certain embodiments, the method includes feeding an anaerobic reaction vessel effluent into the aerobic reaction vessel at a flow rate of from about 75 liters/hour to about 125 liters/hour or more. In certain embodiments, the method includes feeding an anaerobic reaction vessel effluent into the aerobic reaction vessel at a flow rate of from about 90 liters/hour to about 100 liters/hour or more.

In certain embodiments, the method includes flowing the wastewater through the aerobic reaction vessel for a residence time of from about 2 hours to about 9 hours. In certain embodiments, the method includes flowing the wastewater through the aerobic reaction vessel for a residence time of from about 3 hours to about 8 hours. In certain embodiments, the method includes flowing the wastewater through the aerobic reaction vessel for a residence time of from about 4 hours to about 7 hours.

In certain embodiments, provided the anaerobic wastewater in the anaerobic reaction vessel includes an anaerobic concentration one or more heavy metals, the method includes reducing the concentration of the one or more heavy metals in the wastewater by from about 1% to about 30% or more, based on the anaerobic concentration. In certain such embodiments, the method includes reducing the concentration of the one or more heavy metals in the wastewater by from about 10% to about 50% or more, based on the anaerobic concentration. In certain such embodiment, the method includes reducing the concentration of the one or more heavy metals in the wastewater by from about 20% to about 70% or more, based on the anaerobic concentration.

In certain embodiments, provided the aerobic wastewater in the aerobic reaction vessel includes an aerobic concentration one or more heavy metals, the method includes reducing the concentration of the one or more heavy metals in the wastewater by from about 1% to about 30% or more, based on the aerobic concentration. In certain such embodiments, the method includes reducing the concentration of the one or more heavy metals in the wastewater by from about 10% to about 50% or more, based on the anaerobic concentration. In certain such embodiments, the method includes reducing the concentration of the one or more heavy metals in the wastewater by from about 20% to about 70% or more, based on the anaerobic concentration.

In certain embodiments, provided that wastewater leaving the aerobic reaction vessel, the anaerobic reaction vessel, or the system wastewater outlet has a heavy metal content of 0.1 mg/l or more, the method includes flowing the wastewater to the aerobic reaction vessel, the anaerobic reaction vessel, or any combination thereof. Such embodiments can provide a benefit of allowing treated wastewater to be flowed through the bioremediation system one or more times, until a desired or acceptable heavy metal content in the wastewater has been achieved.

### EXAMPLES

### Example I: Bioremediation of Heavy Metals by Cyanobacteria and Sulfate-Reducing Bacteria

A. Selection of Microorganism Strains for Inoculation of Pilot Scale and Field Trials

A series of experiments was performed to assess the potential of microorganisms for the bioremediation of AMD effluents collected from site-specific locations in Arizona and Canada. A library of extremophiles was generated with the most likely capability and potential to be utilized as an inoculum for bioaugmentation during enhanced in situ bioremediation. Thus, tests were performed to assess the capabilities of cyanobacteria (chosen based on their physiological requirements and metabolic traits) to remove heavy metals and increase pH from effluents with unique water chemistry. As an ancillary objective, additional sets of experiments were conducted to assess the efficiency of bioremediation using anaerobic sulfate-reducing bacteria. To choose the microorganisms for this bioremediation purpose, two main criteria were used including:
1. The high tolerance of microorganisms to survive in the toxic environmental conditions (with a high concentration of heavy metals and low pH).
2. The metabolic capacity of the microorganisms to stabilize, precipitate, or absorb the heavy metal residues from the environment.

Water samples from each industrial site were collected and transferred to the laboratory for the analytical assays. Samples were kept cold (covered by ice) during the transportation. The chemical composition of each sample was determined upon receipt at the laboratory. Based on the type of contamination and the chemical composition of the water samples, a list was determined of microorganisms that can effectively remove the heavy metals from the contaminated water samples and also increase the pH of acidic effluents from the acid mine drainage were screened. Among the four most prominent different strains of microorganisms screened (i.e., G. sulphuraria, Spirulina platensis, S. elongatus, and Sulfur Reducing Bacteria), Galderia sulphuraria was capable of growing in very acidic conditions (pH of 2.7), with some removal of heavy metals, indicating that this particular microorganism could be used in extreme low pH effluents. Spirulina platensis also showed great promises for bioremediation, significantly removing heavy metals while concomitantly increasing pH in the effluent over time during growth. Desulfovibrio vulgaris, a sulfate-reducing bacteria also provided noticeable removal of heavy metals (>95%) and an increase in pH; however, compared to cyanobacteria, these bacteria require a continuous supply of organic carbon as an electron donor, leading to additional operational complexity and costs. Therefore, treatment using combined microorganisms, i.e., algae and sulfate-reducing bacteria, may provide the best results. In this case, the algae biomass waste generated during phytoremediation could serve as a substrate for growth of the sulfate-reducing microorganisms. The data provided useful background information on the most ideal biological inoculum to be used for the development of an efficient and commercially viable technology for heavy metal bioremediation.

After initial laboratory screening and establishment of the most promising microorganisms to be used in bioremediation at the field scale, the next step is to scale up the process. Therefore, for phase II, it was proposed to design, implement and, monitor a pilot-scale treatment unit at an industrial site in the United States. The interchangeable system modularity enables the system to be configured to best fit the needs of each treatment site.

B. Experimental Design

The following steps were performed at the laboratory scale for culturing the microorganisms and preparing assays of microbial cell growth.

All cell cultures were grown under sterile conditions by using a biosafety cabinet class II and laminar hood. Frozen cells were revived initially in liquid media. For each species of Cyanobacteria, a plate of agar culture was provided to observe single colonies and to make sure there was no contamination in the stock culture. Plates of agar culture were prepared for all species including Cyanobacteria and microalgae (Galdieria sulphuraria) and E. coli (used for gene cloning). D. vulgaris as the Sulfur Reducing Bacteria (SRBs) were cultured under anaerobic conditions using an anaerobic chamber.

A stock cell culture was made for each strain using an automated bioreactor (Eppendorf-bioprocessor 115 and 120). The system was equipped with software for adjustment of experimental conditions including pH, temperature, gas flow, etc. The system was connected to the pH and temperature sensors to keep the experimental conditions consistent during growth. Different aliquots of stock cell cultures were made for each species and mixed with water samples from each mining site. Cell cultures were maintained in shaking flasks. Samples were collected under sterile conditions at different time points and sent for data analysis.

C. Materials and Methods

### 1. Cyanobacteria

Experiments were conducted in lab-scale batch reactors. The reactors were prepared by adding effluent obtained from a specific site in Arizona or Canada, then inoculated with a particular strain of Cyanobacteria. The reactors were inoculated with either Galdieria sulphuraria or Spirulina platensis. These organisms were chosen because of their reported efficiency to remove heavy metals from water, as well as their metabolic capacity to thrive in acidic conditions while removing heavy metals. Reactors were either kept under a light source (Light intensity of 70 μmol photons m⁻²s⁻¹) and continuous agitation at room temperature, or under anaerobic conditions. Samples were taken over time for analyses of biomass growth, heavy metal concentrations, and pH.

### 2. Sulfate-Reducing Bacteria

Experiments were also performed in lab-scale reactors to assess the efficiency of biologically mediated anaerobic sulfate-reducing activities for the removal of heavy metals and an increase in pH. Batch reactors were prepared by dilution of the raw effluent with nutrient growth medium (1:1) purged with 5% CO2, 5% H2, balanced N2. The composition of the growth medium was (g/L): MgSO4 (2), sodium citrate (5), CaSO4 (1), NH4Cl (1), K2HPO4 (0.5), sodium lactate (3.5), yeast extract (1). Desulfovibrio vulgaris, which is a model SRB used to represent several sulfate-reducing activities in different environmental scenarios, was used as an inoculum. Reactors were kept in the dark inside an incubator set at 30° C. Samples were taken over time for analyses of cell growth, sulfate, and heavy metal concentrations, as well as pH.

### 3. Analytical Methods

Cell concentrations were obtained spectrophotometrically by optical density (OD; 680 nm for cyanobacteria, 600 nm for SRB). pH was measured in the reactors daily. For heavy metal analysis, samples were withdrawn from reactors over time, centrifuged for biomass and precipitate removal, and then the supernatants were sent to a certified third lab (ALS Houston, Tex.) for determination of heavy metals (EPA approved method SW6020) and sulfate (EPA approved method E300) concentrations.

D. Results

### 1. Cyanobacteria

For growth in a highly acidic environment, the number of Cyanobacteria species is very limited compared to a neutrophilic environment. For instance, the red alga Galdieria sulphuraria, the most acidophilic Cyanobacteria known, was selected as a potential candidate for bioremediation of AMD effluents. This extremophile strain, which is dominant in sulfuric acidic hot springs worldwide, can withstand pH levels ranging from 0.1-5.0. In the laboratory, G. sulphuraria showed good growth at a pH of 2.7. Samples of cell cultures were collected at different time points. Optical density (OD) of measurements of cell cultures showed an increase in cell population density over time. Before the measurement of optical density, first a sample of cells was observed under the microscope to see the morphology and homogeneity of the cell culture. Cell samples were transferred to 96 well plates, and optical density (OD) was measured by a plate reader.

The heavy metal removal efficiency observed for G. sulphuraria varied noticeably among the samples tested. Compared to previously published data, the removal efficiency measured was comparatively lower; however, the concentrations of metals present in the samples tested were orders of magnitude higher than those reported values, indicating the maximum threshold capacity for this strain.

Heavy metal removal efficiencies (RE) obtained using G. sulphuraria are shown in TABLE I below. Changes in RE are expected depending on the concentration of CO2 used as electron donor, the composition of nutrients, reactor type and configuration, as well as effluent characteristics.

TABLE I

| Mining Effluent | Heavy Metal | Initial Concentration (mg/L) | Removal (%) |
|---|---|---|---|
| Sample 1 | Nickel | 0.002 | >95 |
| | Zinc | 0.0098 | >95 |
| Sample 2 | Copper | 5.73 | 65 |
| | Iron | 2.08 | 10 |
| | Aluminum | 62.6 | 25 |
| Sample 3 | Copper | 4.2 | 12 |
| | Iron | 4.25 | 20 |
| Sample 4 | Copper | 464 | 30 |
| | Aluminum | 522 | 30 |
| | Nickel | 1.14 | 45 |
| | Zinc | 19.7 | 70 |

G. sulphuraria did not contribute to an increase in pH in effluent samples tested, remaining at pH 2.3 for the experimental time frame. For AMD effluents with a very acidic pH, G. sulphuraria should be considered at earlier stages of bioremediation before a polishing step downgradient in the treatment train. The main advantage of G. sulphuraria resides in its capacity to grow at extremely low pH that may not be tolerated by any other organisms. Thus, over time, the ecosystem generated by G. sulphuraria proliferation can unfold to milder pH conditions needed for the successive growth of other microorganisms.

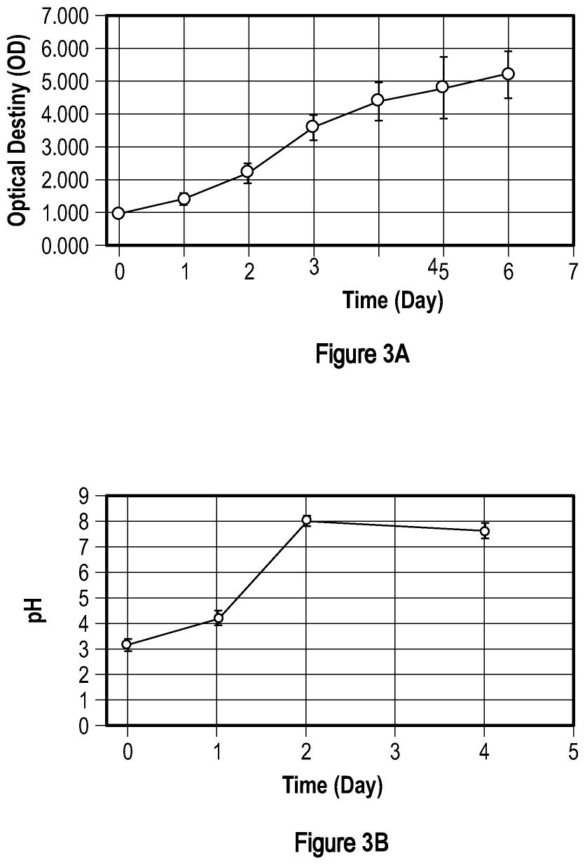

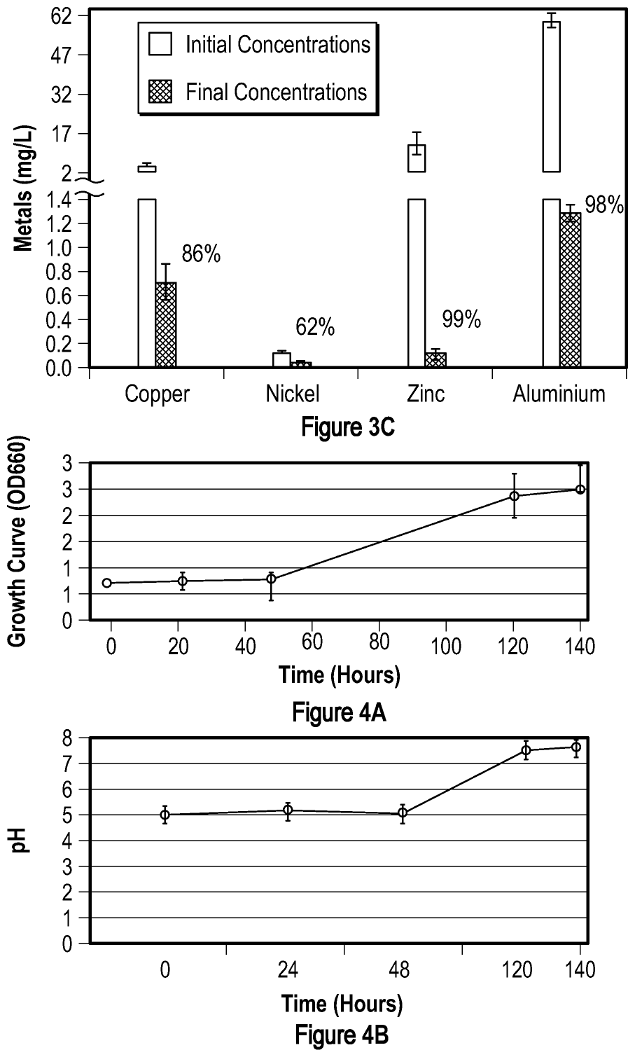

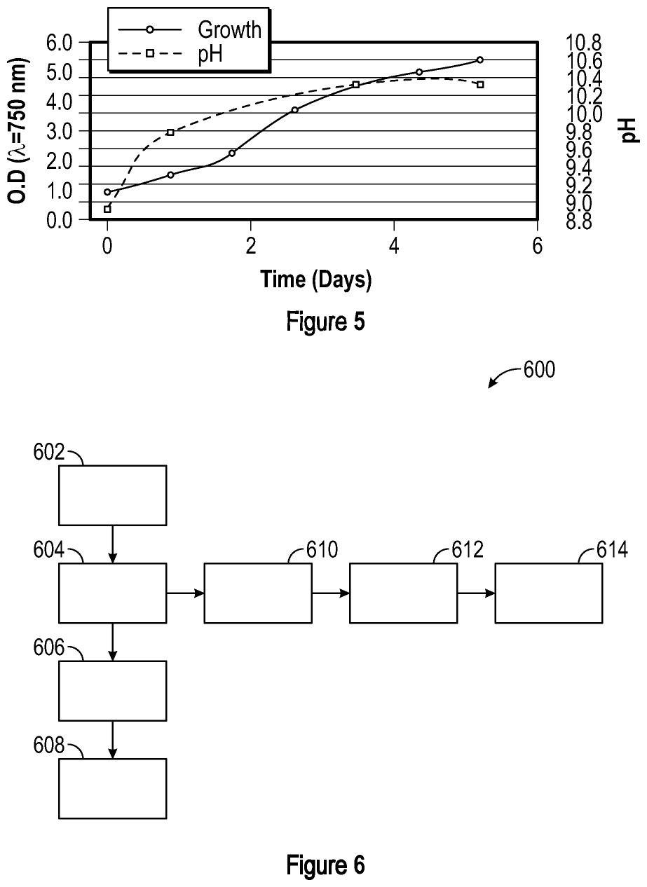

Algae strains such as Spirulina sp, Chlorella, Scenedesmus, Cladophora, Oscillatoria, Anabaena, and Phaeodactylum tricornutum have shown the capacity to remove a considerable volume of heavy metals from AMD. These microalgae act as “hyper-accumulators” and “hyper-adsorbents” with high selectivity for different metals. The bioremediation potential of S. platensis was investigated as a model strain to serve as a possible inoculum for the bioremediation of effluents from the Arizona and Canada sites. S. platensis was chosen not only for its recognized capacity to biologically remove heavy metals, but also to generate high alkalinity, which is essential for additional removal of metals by precipitation during treatment. This strain has shown to keep high metal accumulation capacity during several reactor cycles. A growth curve measured for S. platensis is shown in FIG. 3A. The associated increase in pH is shown in FIG. 3B; the graph illustrates the pH of water samples increased from 3.1 to 8 over 4 days after the addition of S. platensis to the field's water sample. The heavy metal removal efficiency obtained is depicted in FIG. 3C; the graph illustrates different percentages of decrease in concentrations of heavy metals (Copper, Nickel, Zinc, Aluminum) in the effluent after 3 days of treatment with S. platensis.

Typical heavy metal removal efficiencies (RE) reported for AMD effluents using S. platensis are shown below in TABLE 2. Changes in RE are expected depending on the composition of nutrients, reactor type, and configuration, as well as variations in effluent characteristics, including the presence of potential inhibitors.

TABLE 2

| Organism | Effect of pH | Metals | Removal Efficiency (%) |
|---|---|---|---|
| S. platensis | Increase from 3.1 to 8 | Cu | 86 |
| | | Fe | 70 to >95 |
| | | Ni | 63 |
| | | Zn | >95 |
| | | Al | >95 |

This organism can continuously generate alkaline chemicals that act to neutralize the acidity of the AMD through the production of inorganic bicarbonate salts. Overall, S. platensis was the most effective inoculum screened in this work with the highest and most consistent heavy metal removal efficiencies.

### 2. Anaerobic Sulfate-Reducing Bacteria

It is known that SRBs can effectively remove heavy metals from acid mining drainage effluents. During sulfate-reducing activity, sulfate is reduced to hydrogen sulfide, which complexes with metals that precipitate out of solution as metal sulfides (e.g., iron sulfide). This biologically mediated abiotic reaction is perhaps the most important contribution to a greater fraction of heavy metal removal. However, SRB is also capable of biosorption, where the metals adsorbed to the cell surface are later removed from effluent by precipitation as sludge.

D. vulgaris was cultured under anaerobic conditions. The cell growth curve was plotted by measurement of the optical density of cell culture at different time points (FIG. 4A). The resulting increase in pH is shown in FIG. 4B; the graph illustrates the effect of SRB culture on pH increase over time.

The heavy metal removal efficiencies (RE) using D. vulgaris as sulfate-reducer and lactate as electron donor (carbon source), at a pH of 5, resulted in a removal efficiency of 100% for Cu, Ni, Zn, Fe, and Al. Changes in RE are expected depending on bacteria strain, electron donor used, composition of nutrients, reactor type and configuration, as well as effluent characteristics.

Most SRBs grow optimally between pH 6 and 8; pH levels outside this range can decrease sulfate reduction and the rate of metal removal capacity. However, some SRB species can tolerate pH values ranging from 3.6 to 9.5. During sulfate-reducing activity, carbonates are formed, which helps to increase the pH. This may explain the increase in pH observed from 5 to 8 after 5 days of incubation (FIG. 4B). Overall, these results suggest anaerobic SRBs can effectively remove heavy metals while increasing pH that meets environmental regulations.

E. Conclusions

It was evident that some microorganisms performed differently, most likely due to their exclusive physiological requirements. Therefore, treatability tests are critical in the earlier stages of the bioremediation project, allowing the identification of the most appropriate inoculum candidates to perform based on specific environmental and water chemical characteristics of each particular site. G. sulphuraria showed superior growth in very acidic conditions (pH 2.7), with reasonable removal of heavy metals, indicating that this particular source of inoculum could be most appropriate for sites with extremely low pH. Among the Cyanobacteria tested, S. platensis showed the greatest bioaugmentation potential in the samples tested, removing heavy metals significantly while concomitantly increasing pH. The data obtained here are in agreement with current cutting edge emerging trends of employing microalgae in phytoremediation of heavy metals, due to several benefits including abundant availability, inexpensive, excellent metal removal efficiency, and eco-friendly nature. These lab-scale experiments provided useful insights to help the development and implementation of efficient and commercially viable technology for microalgae-based heavy metal bioremediation.

Regarding SRBs, D. Vulgaris was very effective to remove heavy metals and increase pH. Nonetheless, it is worth mentioning that compared to Cyanobacteria, treatment relying on SRB activity requires a continuous supply of organic carbon as an electron donor for bacterial growth. The addition of a carbon source can be considered a disadvantage due to incremental costs with consumables. The production of hydrogen sulfide should also be considered, since besides its bad odor, it is also toxic and corrosive. The production of algae biomass waste generated during bioremediation can serve as an external source of organic carbon and nutrients to promote the growth of SRB communities, thus helping to offset the economic aspects.

F. Field Scale Implementation

Pilot-scale tests allowed the most accurate determination of the engineering parameters for full-scale operations, including hydraulic residence times, reactor volumes, kinetics, biomass yield, and associated waste sludge, energy, input of chemicals, and CO2 mass balance. The capability to fast screen microorganisms to find the best choices as inoculums for bioremediation of AMD, and to engineer the best candidates for accelerated bioremediation, will be applied to field scale implementations. The operation process has been scaled up from test tube to 1 L and up to 1,250 liters by using automated bioreactors at different scales. Standard bioreactors were used which were equipped with a commander software that maintained stable culture conditions by connections to pH and temperature sensors. All bioreactors were remotely controllable, which will be helpful for monitoring operations in the field.

### Example II: Removal of Heavy Metals from Mining Effluents by Engineered Synechococcus elongatus Strains Expressing Metallothioneins

Engineered microorganisms were developed to facilitate removing heavy metals from acid mine drainage. The successfully engineered Synechococcus elongatus was capable of overexpressing metallothioneins proteins involved with the absorption of heavy metals. As a result, compared to wild type, the engineered Cyanobacteria removed Fe, Al, and Ni at much higher rates, demonstrating the capability of synthetic biology to enhance bioremediation.

### A. Cloning Strategy for Creating Recombinant Microorganisms.

The bioaccumulation capacity of S. elongatus was enhanced by increasing the copy number of the metallothionein gene in its genome using a gene-editing method. A standard cloning strategy was used to create plasmids containing one and three copies of the metallothionein-encoding SmtA gene. Transformation and integration of the SmtA gene into the genome of Cyanobacteria was then carried out.

Cyanobacteria strain Synechococcus elongatus (henceforth, S2434 strain) was obtained from a commercial microorganism collection. The Cyanobacteria were grown and maintained using standard BG11 media. Standard E. coli strain DH5α was obtained from a commercial source and grown on Luria-Bertani media with the appropriate amount of antibiotics for selection.

Generally, cloning was performed using the pSyn6-SmtA plasmid sequence (SEQ ID NO: 1), including the HindIII restriction site AAGCTT (SEQ ID NO: 2), a smtA gene fragment (SEQ ID NO: 3), the BamHI restriction site GGATCC (SEQ ID NO: 4), a p2A linker sequence GCCACCAACTTTAGCCTGCTCAAACAAGCCGGCGATGTGGAAGAGAACCCCGGTCCC (SEQ ID NO: 5), an upstream NSI integration site to S. elongatus (SEQ ID NO: 6) including upstream NSI_site_F (SEQ ID NO: 7) and upstream NSI_upstream (Reverse) (SEQ ID NO: 8); a downstream NSI integration site to S. elongatus (SEQ ID NO: 9) including downstream NSI_downstream (forward) (SEQ ID NO: 10), downstream NSI pSyn6_insert-downstream (SEQ ID NO: 11) and downstream NSI_site_R (SEQ ID NO: 12); and a Spectinomycin resistance gene (SEQ ID NO: 13).

In the first approach, a gene encoding a metallothionein protein (SmtA, SEQ ID NO: 16) was amplified from the Cyanobacteria genome using the polymerase chain reaction (PCR) technique. The PCR product was confirmed by gel electrophoresis, before being cloned into a commercial vector (GeneArt™ Synechococcus Protein Expression Vector, Thermo Fisher Scientific Inc). After confirmation by Sanger sequencing, the vector containing the SmtA gene was transformed into Cyanobacteria using the heat-shock method. Engineered cyanobacteria (S2434-SmtA) were grown on BG11 with antibiotics. The presence of the SmtA gene in Cyanobacteria was confirmed using PCR and gel electrophoresis. The culture was maintained before testing with a wastewater sample.

In the second approach, a gene construct of three copies of the SmtA gene was designed and synthesized using a chemical method, in order to express a 3×SmtA protein (SEQ ID NO: 17). The construct was cloned into the commercial vector (GeneArt™ Synechococcus Protein Expression Vector, Thermo Fisher Scientific Inc.). After confirmation by Sanger sequencing, the vector was transformed into Cyanobacteria using the heat-shock method. Engineered Cyanobacteria (S2434-3×SmtA) were grown on BG11 with antibiotics. The presence of the 3×SmtA construct in the Cyanobacteria was confirmed using PCR and gel electrophoresis. The culture was maintained in BG11 media before testing with a wastewater sample.

Generally, cloning was performed using the pSyn6_3×smtA plasmid sequence (SEQ ID NO: 14), including the HindIII restriction site AAGCTT (SEQ ID NO: 2), a smtA 3× gene fragment (SEQ ID NO: 15), the BamHI restriction site GGATCC (SEQ ID NO: 4), a p2A linker sequence (SEQ ID NO: 5), an upstream NSI integration site to S. elongatus (SEQ ID NO: 6) including upstream NSI_site_F (SEQ ID NO: 7) and upstream NSI_upstream (Reverse) (SEQ ID NO: 8); a downstream NSI integration site to S. elongatus (SEQ ID NO: 9) including downstream NSI_downstream (forward) (SEQ ID NO: 10), downstream NSI pSyn6_insert-downstream (SEQ ID NO: 11) and downstream NSI_site_R (SEQ ID NO: 12); and a Spectinomycin resistance gene (SEQ ID NO: 13).

### B. Heavy Metal Removal Assay

For the heavy metal removal assay, cultures of engineered cyanobacteria (S2434-SmtA or S2434-3×SmtA) were mixed with wastewater sample at 1:1 volume ratio. The assay was monitored for 4 days (96 hours). Samples were then sent for metal analysis by ALS Environmental (Houston).

### C. Results

Results from wastewater treatment assays are shown in TABLE 3 and TABLE 4 below. The results show that the engineered cyanobacteria, especially S2434-3×SmtA, performed better than the wild type (non-engineered cyanobacteria) in removing heavy metal. The result was most prominent with iron. TABLE 3 shows concentrations of heavy metal ions before and after treatment with non-engineered S2434 (s2434-wt), 52434-SmtA, and S2434-3×SmtA. Only S2434-SmtA and S2434-3×SmtA were capable of removing iron ions from the sample. TABLE 4 shows the percentage of heavy metal ions removed from the wastewater sample.

TABLE 3

| | Initial | Final concentration (mg/L) | | |
|---|---|---|---|---|
| Ions | Conc | | S2434 | S2434 |
| | (mg/L) | S2434wt | SmtA | 3xSmtA |
| Copper | 5.73 | 1.59 | 1.3 | 1.69 |
| Iron | 2.08 | 2.1 | 1.32 | 1.45 |
| Nickel | 0.134 | 0/111 | 0.0936 | 0.102 |
| Aluminum | 62.6 | 42.8 | 35.2 | 31.8 |

TABLE 4

| | Removal (%) | | |
|---|---|---|---|
| Ions | S2434wt | S2434 SmtA | S2434 3xSmtA |
| Copper | 72 | 77 | 71 |
| Iron | 0 | 37 | 30 |
| Aluminum | 32 | 44 | 49 |
| Nickel | 17 | 30 | 24 |

### D. Conclusions

The results demonstrates the capability of engineering cyanobacteria for heavy metal removal from acid mine drainage. Two Cyanobacteria strains have been engineered for the overproduction of metallothionein, proteins that can remove metal ions. As these microbes can consume CO2 for their growth, this is a significant demonstration of carbon-negative bioremediation.

### Example III: Removal of Heavy Metals from AMD Effluents by Electrochemistry

This work demonstrates a cheaper and lower carbon footprint alternative to lime treatment by the use of a NaCl in an electrochemical plus biological process. The use of electrochemistry was shown to, in combination with bioremediation, a) demonstrate the utility for carbonate production from NaCl for use as a substrate to enhance photosynthetic microorganism growth and kinetics, b) present an option as a preliminary effluent treatment to alleviate extreme low pH that could be inhibitory to a successful bioremediation downgradient in the treatment train; and c) demonstrate the utility of production of carbonates in situ, as a means to provide a local source of carbonates from salt (NaCl) and CO2. The system was very robust to significantly remove >95% of all heavy metals, while increasing the pH from 2 to 8. The yield of carbonates using NaCl was 1.4 g/L/h.

### A. Materials and Methods

### 1. Cation Exchange Membrane

A Nafion ion-exchange membrane (cation exchange membrane, Fuel Cell Earth Co., Boston, USA) was used in this study. According to the manufacturer, this is an active and highly durable membrane for electrolysis applications with a high transport number of Na+ (>0.9).

### 2. Brine Solutions

Brine solutions were prepared by dissolving analytical grade NaCl, and NaHCO3 (supplied by Sigma-Aldrich CO.) in Milli-Q water. Due to NaHCO3 limited solubility in water solution (i.e., 96 g/L). The reactor was designed by connecting two 200 mL flasks separated by the selective membrane. One reactor was filled with 200 ml of the saturated NaCl (360 g/L; anode side) and the other with 200 mL of NaHCO3 solution (0.5 M or 42 g/L; cathode side).

### 3. Membrane Electrolysis System and Experimental Protocol

A Nafion ion-exchange membrane (cation exchange membrane, Fuel Cell Earth Co., Boston, US) was used in this study and placed between two 200 mL each reactor connected. According to the manufacturer, this is an active and a highly durable membrane for electrolysis applications with a high transport number of Na+ (>0.9). Brine solutions were prepared by dissolving analytical grade NaCl, and NaHCO₃ (supplied by Sigma-Aldrich CO.) in Milli-Q water. In each electrochemical unit, 200 ml of the saturated NaCl (360 g/L, in the anode side) and 200 mL NaHCO3 solution (0.5 M or 42 g/L, in cathode side) were utilized. The membrane electrolysis system consisted of an electrolysis cell (Adams & Chittenden Scientific Glass, US), a variable power supply (DC Power Supply Variable 30V, 5A, Longwei, USA), and a liquid separator connected between two glass compartments. The anode and cathode materials were made of graphite to prevent heavy metal impurities and to provide resistance to corrosion by acid formation. The reaction took place in batch mode under an excess of NaCl in the anode side to prevent a significant drop in NaCl concentration. The power supplied to the electrolysis was kept at constant voltage and current. A reference cell (Gamry instrument, US) was used in the anode side to monitor the standard reduction potential of chlorine gas formation. The produced gas in the anode (Cl2) and cathode (H2) was vented properly. At the beginning of the experiment, the anode semi-cell was filled with the brine solution and the cathode semi-cell was filled with NaHCO₃ dissolved in Milli-Q water. During the experiment, H2 is reduced in the cathode side while chlorine is oxidized in the anode side. Free sodium ion (Na+) passed from anode to cathode side through the ion-exchange membrane forming NaOH as the H2 is reduced to react with free hydroxyl ions. The produced NaOH concentration can increase by 50% NaOH with greater ability to chemically capture and trap CO2 from a very low concentration (400 ppm in the air) to pure CO2. The system was tested using pure CO2 at this stage to demonstrate the production of NaHCO3.

### 4. Analytical Measurements

Each experiment was conducted for 3 hours, and the samples were collected (5 ml from the cathode side) every 30 minutes for further analysis. The production of NaHCO₃ was determined by a titration method. 2 mL of cathode sample was diluted in 8 ml DI water in a beaker under agitation using a magnet stirrer and at room temperature. Then, acid (HCl 0.1 M), was utilized for titration to determine bicarbonate and total alkalinity in the solution.

### 5. Results

During the electrochemical reaction, 0.7 g of NaCl and 0.52 g of CO2 were consumed to produce 1 g of NaHCO₃ (production rate of 1.4 g/L/h). System conditions were a voltage of 3.7 and a current of 80 mA. The production of carbonates and consumption of H+ and CO2 led to an increase in pH. An increase in pH from 2 to 8 was seen during the electrochemical reaction, with the formation of carbonates. Metal absorption and dissolution are very dependent on pH, which should be kept at ideal range; otherwise, metal can dissolve back from precipitates (e.g., dissolution occurring at pH greater than 10). The pH can be kept at ideal ranges by controlling reactor kinetics and residence times.

As H+ reacts with HCO3-, H2CO3 forms, but since the pH>8, H2CO3 is unstable and decomposes to H2O+CO2. Experimentally, 10-20 mL of NaHCO2 (2 M) were collected (see TABLE 5) and then field samples were titrated dropwise into it. This titration continued until reaching a stable pH=7 (neutralization point), allowing an estimate of how much NaHCO₃ would be required to neutralize the effluent pH. For example, the data in TABLE 5 shows that it was possible to treat 370 mL of raw effluent from EMO-M using 20 mL (2M NaHCO3; a ratio of 1:18.5). In a continuous flow-through system pH is maintained constant (the pH can be set at 8-9) based on adjustment of the reactor's residence time and kinetics to account for potential carbonic acid limitations and an associated pH increase.

The volume ratio of NaHCO₃ required to bring the raw effluent to pH 7 is shown below in TABLE 5. A lower or higher pH can be achieved by increasing or decreasing the dosage of NaHCO3, respectively.

TABLE 5

| | | | Ration (v:v) |
|---|---|---|---|
| Field | Volume of NaHCO3 | Volume of treated | Effluent/NaHCO3 |
| Sample | (2 M) (mL) | effluent (mL) | to reach pH 7 |
| EMO-M | 20 | 370 | 18.5 |
| EMO-1 | 20 | 250 | 12.5 |
| Deep pit | 10 | 3 | 0.3 |

As the pH increases, heavy metals complex with carbonates and precipitate. Similar effects are observed in conventional treatment using lime. The result is the precipitation of heavy metals from solution. A significant decrease in the concentrations of heavy metals was observed in all samples tested after the electrochemical reaction. Sodium bicarbonate may not be as efficient in removing metals from solutions as other bases, however, it does a great job in neutralizing excess acidity, which helps wastewater pH to meet discharge standards. Two different mechanisms likely contributed to the precipitation of the observed metals. First, metal speciation takes place during interaction with bicarbonate to form metal (bi)carbonate complexes. During this process, the solubility of bicarbonate decreases (which was already much lower than NaOH), and precipitation is quickly observed. Second, the formation of precipitates (sludge) can also strongly attract and bond dissolved metals further assisting heavy metals removal.

The carbonates produced during electrochemical reactions were tested as a buffer and as a source of CO2 for the growth of Spirulina platensis. Growth of Spirulina platensis in a reactor was prepared with an AMD sample diluted with carbonate-rich effluent from the electrochemical reactor. The pH did not increase in this case due to cell growth (only 1 unit increment) because it was already within an ideal range for cell metabolism (i.e., pH of ˜9-10). The cells showed a good growth pattern (FIG. 3A), considering that these organisms are known to like an alkaline pH. The results show that the use of electrochemistry can be useful upstream of treatment when dealing with extremely low pH, to provide adequate pH and carbonate buffering capacity to enhance the efficiency of the bioremediation downgradient in the treatment train.

### 6. CONCLUSIONS

The concentration of heavy metals decreased significantly after electrochemical reaction, while pH increased from 2 to 8.4, indicating the usefulness of the electrochemical process for AMD effluent treatment. For the electrolyte selection, we four chemical elements were initially selected, such as K (potassium), Na (sodium), Mg (magnesium), and Ca (calcium). Then, it was concluded that Mg and Ca compounds suffer from solubility issues; therefore, Na and K were considered as the best candidates. From there, Na2CO3, NaOH, and KOH were selected as the leading electrolytes. Among those, Na2CO3 showed the best results together with NaCl as the electrolyte, which is readily available at a low cost. The yield of carbonate was 1.4 g/L/h.

APPENDIX

SEQ ID NO: 1 -
CTGGTTGGCTTGGTTTCATCAGCCATCCGCTTGCCCTCATCTGTTACGCCGGCGGTAGCC
GGCCAGCCTCGCAGAGCAGGATTCCCGTTGAGCACCGCCAGGTGCGAATAAGGGACAG
TGAAGAAGGAACACCCGCTCGCGGGTGGGCCTACTTCACCTATCCTGCCCGGCTGACGC
CGTTGGATACACCAAGGAAAGTCTACACGAACCCTTTGGCAAAATCCTGTATATCGTGC
GAAAAAGGATGGATATACCGAAAAAATCGCTATAATGACCCCGAAGCAGGGTTATGCA
GCGGAAGATCGATAATCTCATGACCAAAATCCCTTAACGTGAGTTTTCGTTCCACTGAG
CGTCAGACCCCGTATAAAAGATCAAAGGATCTTCTTGAGATCCTTTTTTTCTGCGCGTA
ATCTGCTGCTTGCAAACAAAAAAACCACCGCTACCAGCGGTGGTTTGTTTGCCGGATCA
AGAGCTACCAACTCTTTTTCCGAAGGTAACTGGCTTCAGCAGAGCGCAGATACCAAATA
CTGTTCTTCTAGTGTAGCCGTAGTTAGGCCACCACTTCAAGAACTCTGTAGCACCGCCT
ACATACCTCGCTCTGCTAATCCTGTTACCAGTGGCTGCTGCCAGTGGCGATAAGTCGTG
TCTTACCGGGTTGGACTCAAGACGATAGTTACCGGATAAGGCGCAGCGGTCGGGCTGA
ACGGGGGGTTCGTGCACACAGCCCAGCTTGGAGCGAACGACCTACACCGAACTGAGAT
ACCTACAGCGTGAGCTATGAGAAAGCGCCACGCTTCCCGAAGGGAGAAAGGCGGACA
GGTATCCGGTAAGCGGCAGGGTCGGAACAGGAGAGCGCACGAGGGAGCTTCCAGGGG
GAAACGCCTGGTATCTTTATAGTCCTGTCGGGTTTCGCCACCTCTGACTTGAGCGTCGAT
TTTTGTGATGCTCGTCAGGGGGGCGGAGCCTATGGAAAAACGCCAGCAACGCGGCCTT
TTTACGGTTCCTGGCCTTTTGCTGGCCTTTTGCTCACATGTGTGCTGGGCCCCAATGCCT
TCTCCAAGGGCGGCATTCCCCTGACTGTTGAAGGCGTTGCCAATATCAAGATTGCTGGG
GAAGAACCGACCATCCACAACGCGATCGAGCGGCTGCTTGGCAAAAACCGTAAGGAAA
TCGAGCAAATTGCCAAGGAGACCCTCGAAGGCAACTTGCGTGGTGTTTTAGCCAGCCTC
ACGCCGGAGCAGATCAACGAGGACAAAATTGCCTTTGCCAAAAGTCTGCTGGAAGAGG
CGGAGGATGACCTTGAGCAGCTGGGTCAAGTCCTCGATACGCTGCAAGTCCAGAACAT
TTCCGATGAGGTCGGTTATCTCTCGGCTAGTGGACGCAAGCAGCGGGCTGATCTGCAGC
GAGATGCCCGAATTGCTGAAGCCGATGCCCAGGCTGCCTCTGCGATCCAAACGGCCGA
AAATGACAAGATCACGGCCCTGCGTCGGATCGATCGCGATGTAGCGATCGCCCAAGCC
GAGGCCGAGCGCCGGATTCAGGATGCGTTGACGCGGCGCGAAGCGGTGGTGGCCGAAG
CTGAAGCGGACATTGCTACCGAAGTCGCTCGTAGCCAAGCAGAACTCCCTGTGCAGCA
GGAGCGGATCAAACAGGTGCAGCAGCAACTTCAAGCCGATGTGATCGCCCCAGCTGAG
GCAGCTTGTAAACGGGCGATCGCGGAAGCGCGGGGGGCCGCCGCCCGTATCGTCGAAG
ATGGAAAAGCTCAAGCGGAAGGGACCCAACGGCTGGCGGAGGCTTGGCAGACCGCTG
GTGCTAATGCCCGCGACATCTTCCTGCTCCAGAAGTCTAGATAATCCCTAGCGATCGCA
AGTCCAAAGGTTGTCTACAATCAATATCCAAGCATCAAAAAGCGCCCCATTCGAGGCG
CTTTTTGATTATTCAGACTGCTGTAATTCCGGCAATTAGGTTATTTGCCGACTACCTTGG
TGATCTCGCCTTTCACGTAGTGGACAAATTCTTCCAACTGATCTGCGCGCGAGGCCAAG
CGATCTTCTTCTTGTCCAAGATAAGCCTGTCTAGCTTCAAGTATGACGGGCTGATACTG
GGCCGGCAGGCGCTCCATTGCCCAGTCGGCAGCGACATCCTTCGGCGCGATTTTGCCGG
TTACTGCGCTGTACCAAATGCGGGACAACGTAAGCACTACATTTCGCTCATCGCCAGCC
CAGTCGGGCGGCGAGTTCCATAGCGTTAAGGTTTCATTTAGCGCCTCAAATAGATCCTG
TTCAGGAACCGGATCAAAGAGTTCCTCCGCCGCTGGACCTACCAAGGCAACGCTATGTT
CTCTTGCTTTTGTCAGCAAGATAGCCAGATCAATGTCGATCGTGGCTGGCTCGAAGATA
CCAGCAAGAATGTCATTGCGCTGCCATTCTCCAAATTGCAGTTCGCGCTTAGCTGGATA
ACGCCACGGAATGATGTCGTCGTGCACAACAATGGTGACTTCTACAGCGCGGAGAATC
TCGCTCTCTCCAGGGGAAGCCGAAGTTTCCAAAAGGTCGTTGATCAAAGCTCGCCGCGT
TGTTTCATCAAGCCTTACGGTCACCGTAACCAGCAAATCAATATCACTGTGTGGCTTCA
GGCCGCCATCCACTGCGGAGCCGTACAAATGTACGGCCAGCAACGTCGGTTCGAGATG
GCGCTCGATGACGCCAACTACCTCTGATAGTTGAGTCGATACTTCGGCGATCACCGCTT
CCCTCATAATGTTTAACTTTGTTTTAGGGCGACTGCCCTGCTGCGTAACATCGTTGCTGC
TCCATAACATCAAACATCGACCCACGGCGTAACGCGCTTGCTGCTTGGATGCCCGAGGC
ATAGACTGTACCCCAAAAAAACAGTCATAACAAGCCATGAAAACCGCCACTGCGCCGT
TACCACCGCTGCGTTCGGTCAAGGTTCTGGACCAGTTGCGTGAGCGCATACGCTACTTG
CATTACAGCTTACGAACCGAACAGGCTTATGTCCACTGGGTTCGTGCCTTCATCCGTTTC
CACGGTGTGCGTCACCCGGCAACCTTGGGTAGCAGCGAAGTCGAGGCATTTCTGTCCTG
GCTGGCTATTTAGCGTCTTCTAATCCAGTGTAGACAGTAGTTTTGGCTCCGTTGAGCACT
GTAGCCTTGGGCGATCGCTCTAAACATTACATAAATTCACAAAGTTTTCGTTACATAAA
AATAGTGTCTACTTAGCTAAAAATTAAGGGTTTTTTACACCTTTTTGACAGTTAATCTCC
TAGCCTAAAAAGCAAGAGTTTTTAACTAAGACTCTTGCCCTTTACAACCTCGAAGGAGC
GTCAGATCTCATATGCACCACCACCATCACCACGAAAACCTGTACTTTCAGGGCAAGCT
TATGACCTCAACAACCTTGGTCAAATGCGCTTGTGAGCCCTGTCTCTGCAACGTCGATC
CCAGCAAAGCGATCGATCGCAACGGTCTGTACTACTGCAGCGAAGCCTGTGCCGATGG
CCACACCGGTGGTAGCAAAGGCTGCGGCCACACCGGCTGTAACTGCCACGGCTAAGGA
TCCGCGGTACCAGGCAAACCCATCCCCAACCCCCTGCTGGGCCTGGATAGCACCGGTG
GTGGTCACCACCACCATCACCACTAGAGTACTGTATGCATCGAGTGCCTGGCGGCAGTA
GCGCGGTGGTCCCACCTGACCCCATGCCGAACTCAGAAGTGAAACGCCGTAGCGCCGA
TGGTAGTGTGGGGTCTCCCCATGCGAGAGTAGGGAACTGCCAGGCATCAAATAAAACG
AAAGGCTCAGTCGAAAGACTGGGCCTTCTCGAGTCCCTGCTCGTCACGCTTTCAGGCAC
CGTGCCAGATATCGACGTGGAGTCGATCACTGTGATTGGCGAAGGGGAAGGCAGCGCT
ACCCAAATCGCTAGCTTGCTGGAGAAGCTGAAACAAACCACGGGCATTGATCTGGCGA
AATCCCTACCGGGTCAATCCGACTCGCCCGCTGCGAAGTCCTAAGAGATAGCGATGTG
ACCGCGATCGCTTGTCAAGAATCCCAGTGATCCCGAACCATAGGAAGGCAAGCTCAAT
GCTTGCCTCGTCTTGAGGACTATCTAGATGTCTGTGGAACGCACATTTATTGCCATCAA
GCCCGATGGCGTTCAGCGGGGTTTGGTCGGTACGATCATCGGCCGCTTTGAGCAAAAA
GGCTTCAAACTGGTGGGCCTAAAGCAGCTGAAGCCCAGTCGCGAGCTGGCCGAACAGC
ACTATGCTGTCCACCGCGAGCGCCCCTTCTTCAATGGCCTCGTCGAGTTCATCACCTCTG
GGCCGATCGTGGCGATCGTCTTGGAAGGCGAAGGCGTTGTGGCGGCTGCTCGCAAGTT
GATCGGCGCTACCAATCCGCTGACGGCAGAACCGGGCACCATCCGTGGTGATTTTGGTG
TCAATATTGGCCGCAACATCATCCATGGCTCGGATGCAATCGAAACAGCACAACAGGA
AATTGCTCTCTGGTTTAGCCCAGCAGAGCTAAGTGATTGGACCCCCACGATTCAACCCT
GGCTGTACGAATAAGGTCTGCATTCCTTCAGAGAGACATTGCCATGCCG
SEQ ID NO: 2-
AAGCTT
SEQ ID NO. 3 -
ATGACCTCAACAACCTTGGTCAAATGCGCTTGTGAGCCCTGTCTCTGCAACGTCGATCC
CAGCAAAGCGATCGATCGCAACGGTCTGTACTACTGCAGCGAAGCCTGTGCCGATGGC
CACACCGGTGGTAGCAAAGGCTGCGGCCACACCGGCTGTAACTGCCACGGCTAA
SEQ ID NO. 4-
GGATCC
SEQ ID NO. 5 -
GCCACCAACTTTAGCCTGCTCAAACAAGCCGGCGATGTGGAAGAGAACCCCGGTCCC
SEQ ID. NO. 6-
CCAATGCCTTCTCCAAGGGCGGCATTCCCCTGACTGTTGAAGGCGTTGCCAATATCAAG
ATTGCTGGGGAAGAACCGACCATCCACAACGCGATCGAGCGGCTGCTTGGCAAAAACC
GTAAGGAAATCGAGCAAATTGCCAAGGAGACCCTCGAAGGCAACTTGCGTGGTGTTTT
AGCCAGCCTCACGCCGGAGCAGATCAACGAGGACAAAATTGCCTTTGCCAAAAGTCTG
CTGGAAGAGGCGGAGGATGACCTTGAGCAGCTGGGTCAAGTCCTCGATACGCTGCAAG
TCCAGAACATTTCCGATGAGGTCGGTTATCTCTCGGCTAGTGGACGCAAGCAGCGGGCT
GATCTGCAGCGAGATGCCCGAATTGCTGAAGCCGATGCCCAGGCTGCCTCTGCGATCCA
AACGGCCGAAAATGACAAGATCACGGCCCTGCGTCGGATCGATCGCGATGTAGCGATC
GCCCAAGCCGAGGCCGAGCGCCGGATTCAGGATGCGTTGACGCGGCGCGAAGCGGTGG
TGGCCGAAGCTGAAGCGGACATTGCTACCGAAGTCGCTCGTAGCCAAGCAGAACTCCC
TGTGCAGCAGGAGCGGATCAAACAGGTGCAGCAGCAACTTCAAGCCGATGTGATCGCC
CCAGCTGAGGCAGCTTGTAAACGGGCGATCGCGGAAGCGCGGGGGGCCGCCGCCCGTA
TCGTCGAAGATGGAAAAGCTCAAGCGGAAGGGACCCAACGGCTGGCGGAGGCTTGGC
AGACCGCTGGTGCTAATGCCCGCGACATCTTCCTGCTCCAGAAG
SEQ ID NO. 7-
TGACTGTTGAAGGCGTTGC
SEQ ID NO. 8: -
AGATGCCCGAATTGCTGAAGC
SEQ ID NO. 9: -
CTCGAGTCCCTGCTCGTCACGCTTTCAGGCACCGTGCCAGATATCGACGTGGAGTCGAT
CACTGTGATTGGCGAAGGGGAAGGCAGCGCTACCCAAATCGCTAGCTTGCTGGAGAAG
CTGAAACAAACCACGGGCATTGATCTGGCGAAATCCCTACCGGGTCAATCCGACTCGC
CCGCTGCGAAGTCCTAAGAGATAGCGATGTGACCGCGATCGCTTGTCAAGAATCCCAG
TGATCCCGAACCATAGGAAGGCAAGCTCAATGCTTGCCTCGTCTTGAGGACTATCTAGA
TGTCTGTGGAACGCACATTTATTGCCATCAAGCCCGATGGCGTTCAGCGGGGTTTGGTC
GGTACGATCATCGGCCGCTTTGAGCAAAAAGGCTTCAAACTGGTGGGCCTAAAGCAGC
TGAAGCCCAGTCGCGAGCTGGCCGAACAGCACTATGCTGTCCACCGCGAGCGCCCCTTC
TTCAATGGCCTCGTCGAGTTCATCACCTCTGGGCCGATCGTGGCGATCGTCTTGGAAGG
CGAAGGCGTTGTGGCGGCTGCTCGCAAGTTGATCGGCGCTACCAATCCGCTGACGGCA
GAACCGGGCACCATCCGTGGTGATTTTGGTGTCAATATTGGCCGCAACATCATCCATGG
CTCGGATGCAATCGAAACAGCACAACAGGAAATTGCTCTCTGGTTTAGCCCAGCAGAG
CTAAGTGATTGGACCCCCACGATTCAACCCTGGCTGTACGAATAAGGTCTGCATTCCTT
CAGAGAGACATTGCCATGCC
SEQ ID NO. 10: -
GCAAGCTCAATGCTTGCCTC
SEQ ID NO. 11: -
GGAACGCACATTTATTGCCATCA
SEQ ID NO. 12: -
CCGTGGTGATTTTGGTGTCA
SEQ ID NO. 13: -
TTATTTGCCGACTACCTTGGTGATCTCGCCTTTCACGTAGTGGACAAATTCTTCCAACTG
ATCTGCGCGCGAGGCCAAGCGATCTTCTTCTTGTCCAAGATAAGCCTGTCTAGCTTCAA
GTATGACGGGCTGATACTGGGCCGGCAGGCGCTCCATTGCCCAGTCGGCAGCGACATC
CTTCGGCGCGATTTTGCCGGTTACTGCGCTGTACCAAATGCGGGACAACGTAAGCACTA
CATTTCGCTCATCGCCAGCCCAGTCGGGCGGCGAGTTCCATAGCGTTAAGGTTTCATTT
AGCGCCTCAAATAGATCCTGTTCAGGAACCGGATCAAAGAGTTCCTCCGCCGCTGGACC
TACCAAGGCAACGCTATGTTCTCTTGCTTTTGTCAGCAAGATAGCCAGATCAATGTCGA
TCGTGGCTGGCTCGAAGATACCAGCAAGAATGTCATTGCGCTGCCATTCTCCAAATTGC
AGTTCGCGCTTAGCTGGATAACGCCACGGAATGATGTCGTCGTGCACAACAATGGTGA
CTTCTACAGCGCGGAGAATCTCGCTCTCTCCAGGGGAAGCCGAAGTTTCCAAAAGGTCG
TTGATCAAAGCTCGCCGCGTTGTTTCATCAAGCCTTACGGTCACCGTAACCAGCAAATC
AATATCACTGTGTGGCTTCAGGCCGCCATCCACTGCGGAGCCGTACAAATGTACGGCCA
GCAACGTCGGTTCGAGATGGCGCTCGATGACGCCAACTACCTCTGATAGTTGAGTCGAT
ACTTCGGCGATCACCGCTTCCCTCATAATGTTTAACTTTGTTTTAGGGCGACTGCCCTGC
TGCGTAACATCGTTGCTGCTCCATAACATCAAACATCGACCCACGGCGTAACGCGCTTG
CTGCTTGGATGCCCGAGGCATAGACTGTACCCCAAAAAAACAGTCATAACAAGCCATG
AAAACCGCCACTGCGCCGTTACCACCGCTGCGTTCGGTCAAGGTTCTGGACCAGTTGCG
TGAGCGCAT
SEQ ID NO: 14: -
CTGGTTGGCTTGGTTTCATCAGCCATCCGCTTGCCCTCATCTGTTACGCCGGCGGTAGCC
GGCCAGCCTCGCAGAGCAGGATTCCCGTTGAGCACCGCCAGGTGCGAATAAGGGACAG
TGAAGAAGGAACACCCGCTCGCGGGTGGGCCTACTTCACCTATCCTGCCCGGCTGACGC
CGTTGGATACACCAAGGAAAGTCTACACGAACCCTTTGGCAAAATCCTGTATATCGTGC
GAAAAAGGATGGATATACCGAAAAAATCGCTATAATGACCCCGAAGCAGGGTTATGCA
GCGGAAGATCGATAATCTCATGACCAAAATCCCTTAACGTGAGTTTTCGTTCCACTGAG
CGTCAGACCCCGTATAAAAGATCAAAGGATCTTCTTGAGATCCTTTTTTTCTGCGCGTA
ATCTGCTGCTTGCAAACAAAAAAACCACCGCTACCAGCGGTGGTTTGTTTGCCGGATCA
AGAGCTACCAACTCTTTTTCCGAAGGTAACTGGCTTCAGCAGAGCGCAGATACCAAATA
CTGTTCTTCTAGTGTAGCCGTAGTTAGGCCACCACTTCAAGAACTCTGTAGCACCGCCT
ACATACCTCGCTCTGCTAATCCTGTTACCAGTGGCTGCTGCCAGTGGCGATAAGTCGTG
TCTTACCGGGTTGGACTCAAGACGATAGTTACCGGATAAGGCGCAGCGGTCGGGCTGA
ACGGGGGGTTCGTGCACACAGCCCAGCTTGGAGCGAACGACCTACACCGAACTGAGAT
ACCTACAGCGTGAGCTATGAGAAAGCGCCACGCTTCCCGAAGGGAGAAAGGCGGACA
GGTATCCGGTAAGCGGCAGGGTCGGAACAGGAGAGCGCACGAGGGAGCTTCCAGGGG
GAAACGCCTGGTATCTTTATAGTCCTGTCGGGTTTCGCCACCTCTGACTTGAGCGTCGAT
TTTTGTGATGCTCGTCAGGGGGGCGGAGCCTATGGAAAAACGCCAGCAACGCGGCCTT
TTTACGGTTCCTGGCCTTTTGCTGGCCTTTTGCTCACATGTGTGCTGGGCCCCAATGCCT
TCTCCAAGGGCGGCATTCCCCTGACTGTTGAAGGCGTTGCCAATATCAAGATTGCTGGG
GAAGAACCGACCATCCACAACGCGATCGAGCGGCTGCTTGGCAAAAACCGTAAGGAAA
TCGAGCAAATTGCCAAGGAGACCCTCGAAGGCAACTTGCGTGGTGTTTTAGCCAGCCTC
ACGCCGGAGCAGATCAACGAGGACAAAATTGCCTTTGCCAAAAGTCTGCTGGAAGAGG
CGGAGGATGACCTTGAGCAGCTGGGTCAAGTCCTCGATACGCTGCAAGTCCAGAACAT
TTCCGATGAGGTCGGTTATCTCTCGGCTAGTGGACGCAAGCAGCGGGCTGATCTGCAGC
GAGATGCCCGAATTGCTGAAGCCGATGCCCAGGCTGCCTCTGCGATCCAAACGGCCGA
AAATGACAAGATCACGGCCCTGCGTCGGATCGATCGCGATGTAGCGATCGCCCAAGCC
GAGGCCGAGCGCCGGATTCAGGATGCGTTGACGCGGCGCGAAGCGGTGGTGGCCGAAG
CTGAAGCGGACATTGCTACCGAAGTCGCTCGTAGCCAAGCAGAACTCCCTGTGCAGCA
GGAGCGGATCAAACAGGTGCAGCAGCAACTTCAAGCCGATGTGATCGCCCCAGCTGAG
GCAGCTTGTAAACGGGCGATCGCGGAAGCGCGGGGGGCCGCCGCCCGTATCGTCGAAG
ATGGAAAAGCTCAAGCGGAAGGGACCCAACGGCTGGCGGAGGCTTGGCAGACCGCTG
GTGCTAATGCCCGCGACATCTTCCTGCTCCAGAAGTCTAGATAATCCCTAGCGATCGCA
AGTCCAAAGGTTGTCTACAATCAATATCCAAGCATCAAAAAGCGCCCCATTCGAGGCG
CTTTTTGATTATTCAGACTGCTGTAATTCCGGCAATTAGGTTATTTGCCGACTACCTTGG
TGATCTCGCCTTTCACGTAGTGGACAAATTCTTCCAACTGATCTGCGCGCGAGGCCAAG
CGATCTTCTTCTTGTCCAAGATAAGCCTGTCTAGCTTCAAGTATGACGGGCTGATACTG
GGCCGGCAGGCGCTCCATTGCCCAGTCGGCAGCGACATCCTTCGGCGCGATTTTGCCGG
TTACTGCGCTGTACCAAATGCGGGACAACGTAAGCACTACATTTCGCTCATCGCCAGCC
CAGTCGGGCGGCGAGTTCCATAGCGTTAAGGTTTCATTTAGCGCCTCAAATAGATCCTG
TTCAGGAACCGGATCAAAGAGTTCCTCCGCCGCTGGACCTACCAAGGCAACGCTATGTT
CTCTTGCTTTTGTCAGCAAGATAGCCAGATCAATGTCGATCGTGGCTGGCTCGAAGATA
CCAGCAAGAATGTCATTGCGCTGCCATTCTCCAAATTGCAGTTCGCGCTTAGCTGGATA
ACGCCACGGAATGATGTCGTCGTGCACAACAATGGTGACTTCTACAGCGCGGAGAATC
TCGCTCTCTCCAGGGGAAGCCGAAGTTTCCAAAAGGTCGTTGATCAAAGCTCGCCGCGT
TGTTTCATCAAGCCTTACGGTCACCGTAACCAGCAAATCAATATCACTGTGTGGCTTCA
GGCCGCCATCCACTGCGGAGCCGTACAAATGTACGGCCAGCAACGTCGGTTCGAGATG
GCGCTCGATGACGCCAACTACCTCTGATAGTTGAGTCGATACTTCGGCGATCACCGCTT
CCCTCATAATGTTTAACTTTGTTTTAGGGCGACTGCCCTGCTGCGTAACATCGTTGCTGC
TCCATAACATCAAACATCGACCCACGGCGTAACGCGCTTGCTGCTTGGATGCCCGAGGC
ATAGACTGTACCCCAAAAAAACAGTCATAACAAGCCATGAAAACCGCCACTGCGCCGT
TACCACCGCTGCGTTCGGTCAAGGTTCTGGACCAGTTGCGTGAGCGCATACGCTACTTG
CATTACAGCTTACGAACCGAACAGGCTTATGTCCACTGGGTTCGTGCCTTCATCCGTTTC
CACGGTGTGCGTCACCCGGCAACCTTGGGTAGCAGCGAAGTCGAGGCATTTCTGTCCTG
GCTGGCTATTTAGCGTCTTCTAATCCAGTGTAGACAGTAGTTTTGGCTCCGTTGAGCACT
GTAGCCTTGGGCGATCGCTCTAAACATTACATAAATTCACAAAGTTTTCGTTACATAAA
AATAGTGTCTACTTAGCTAAAAATTAAGGGTTTTTTACACCTTTTTGACAGTTAATCTCC
TAGCCTAAAAAGCAAGAGTTTTTAACTAAGACTCTTGCCCTTTACAACCTCGAAGGAGC
GTCAGATCTCATATGCACCACCACCATCACCACGAAAACCTGTACTTTCAGGGCAAGCT
TATGACCTCAACAACCTTGGTCAAATGCGCTTGTGAGCCCTGTCTCTGCAACGTCGATC
CCAGCAAAGCGATCGATCGCAACGGTCTGTACTACTGCAGCGAAGCCTGTGCCGATGG
CCACACCGGTGGTAGCAAAGGCTGCGGCCACACCGGCTGTAACTGCCACGGCTAAGCC
ACCAACTTTAGCCTGCTCAAACAAGCCGGCGATGTGGAAGAGAACCCCGGTCCCATGA
CCTCAACAACCTTGGTCAAATGCGCTTGTGAGCCCTGTCTCTGCAACGTCGATCCCAGC
AAAGCGATCGATCGCAACGGTCTGTACTACTGCAGCGAAGCCTGTGCCGATGGCCACA
CCGGTGGTAGCAAAGGCTGCGGCCACACCGGCTGTAACTGCCACGGCTAAGCCACCAA
CTTTAGCCTGCTCAAACAAGCCGGCGATGTGGAAGAGAACCCCGGTCCCATGACCTCA
ACAACCTTGGTCAAATGCGCTTGTGAGCCCTGTCTCTGCAACGTCGATCCCAGCAAAGC
GATCGATCGCAACGGTCTGTACTACTGCAGCGAAGCCTGTGCCGATGGCCACACCGGT
GGTAGCAAAGGCTGCGGCCACACCGGCTGTAACTGCCACGGCTAAGGTACCAGGCAAA
CCCATCCCCAACCCCCTGCTGGGCCTGGATAGCACCGGTGGTGGTCACCACCACCATCA
CCACTAGAGTACTGTATGCATCGAGTGCCTGGCGGCAGTAGCGCGGTGGTCCCACCTGA
CCCCATGCCGAACTCAGAAGTGAAACGCCGTAGCGCCGATGGTAGTGTGGGGTCTCCC
CATGCGAGAGTAGGGAACTGCCAGGCATCAAATAAAACGAAAGGCTCAGTCGAAAGA
CTGGGCCTTCTCGAGTCCCTGCTCGTCACGCTTTCAGGCACCGTGCCAGATATCGACGT
GGAGTCGATCACTGTGATTGGCGAAGGGGAAGGCAGCGCTACCCAAATCGCTAGCTTG
CTGGAGAAGCTGAAACAAACCACGGGCATTGATCTGGCGAAATCCCTACCGGGTCAAT
CCGACTCGCCCGCTGCGAAGTCCTAAGAGATAGCGATGTGACCGCGATCGCTTGTCAA
GAATCCCAGTGATCCCGAACCATAGGAAGGCAAGCTCAATGCTTGCCTCGTCTTGAGG
ACTATCTAGATGTCTGTGGAACGCACATTTATTGCCATCAAGCCCGATGGCGTTCAGCG
GGGTTTGGTCGGTACGATCATCGGCCGCTTTGAGCAAAAAGGCTTCAAACTGGTGGGCC
TAAAGCAGCTGAAGCCCAGTCGCGAGCTGGCCGAACAGCACTATGCTGTCCACCGCGA
GCGCCCCTTCTTCAATGGCCTCGTCGAGTTCATCACCTCTGGGCCGATCGTGGCGATCG
TCTTGGAAGGCGAAGGCGTTGTGGCGGCTGCTCGCAAGTTGATCGGCGCTACCAATCCG
CTGACGGCAGAACCGGGCACCATCCGTGGTGATTTTGGTGTCAATATTGGCCGCAACAT
CATCCATGGCTCGGATGCAATCGAAACAGCACAACAGGAAATTGCTCTCTGGTTTAGCC
CAGCAGAGCTAAGTGATTGGACCCCCACGATTCAACCCTGGCTGTACGAATAAGGTCT
GCATTCCTTCAGAGAGACATTGCCATGCCG
SEQ ID NO: 15: -
ATGACCTCAACAACCTTGGTCAAATGCGCTTGTGAGCCCTGTCTCTGCAACGTCGATCC
CAGCAAAGCGATCGATCGCAACGGTCTGTACTACTGCAGCGAAGCCTGTGCCGATGGC
CACACCGGTGGTAGCAAAGGCTGCGGCCACACCGGCTGTAACTGCCACGGCTAAGCCA
CCAACTTTAGCCTGCTCAAACAAGCCGGCGATGTGGAAGAGAACCCCGGTCCCATGAC
CTCAACAACCTTGGTCAAATGCGCTTGTGAGCCCTGTCTCTGCAACGTCGATCCCAGCA
AAGCGATCGATCGCAACGGTCTGTACTACTGCAGCGAAGCCTGTGCCGATGGCCACAC
CGGTGGTAGCAAAGGCTGCGGCCACACCGGCTGTAACTGCCACGGCTAAGCCACCAAC
TTTAGCCTGCTCAAACAAGCCGGCGATGTGGAAGAGAACCCCGGTCCCATGACCTCAA
CAACCTTGGTCAAATGCGCTTGTGAGCCCTGTCTCTGCAACGTCGATCCCAGCAAAGCG
ATCGATCGCAACGGTCTGTACTACTGCAGCGAAGCCTGTGCCGATGGCCACACCGGTG
GTAGCAAAGGCTGCGGCCACACCGGCTGTAACTGCCACGGCTAA
SEQ ID NO: 16: -
MTSTTLVKCACEPCLCNVDPSKAIDRNGLYYCSEACADGHTGGSKGCGHTGCNCHG
SEQ ID NO: 17: -
MHHHHHHENLYFQGKLTSTTLVKCACEPCLCNVDPSKAIDRNGLYYCSEACADGHTGGSK
GCGHTGCNCHGATNFSLLKQAGDVEENPGPMTSTTLVKCACEPCLCNVDPSKAIDRNGLY
YCSEACADGHTGGSKGCGHTGCNCHGATNFSLLKQAGDVEENPGPMTSTTLVKCACEPCL
CNVDPSKAIDRNGLYYCSEACADGHTGGSKGCGHTGCNCHGGTRQTHPQPPAGPG

What is claimed is:

1. A bioremediation system for wastewater treatment comprising:
a system wastewater inlet, a system wastewater outlet, an anaerobic reaction vessel, and an aerobic reaction vessel connected by at least one wastewater flow path;
wherein the anaerobic reaction vessel contains an anaerobic reaction solution,
wherein the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater, increasing an anaerobic pH of the anaerobic wastewater, or reducing an anaerobic concentration of organic compounds in the anaerobic wastewater, or a combination thereof; and
wherein the aerobic reaction vessel contains an aerobic reaction solution, wherein the aerobic reaction solution contains an aerobic concentration of at least one aerobic microorganism in an aerobic wastewater, wherein the at least one aerobic microorganism contains a metalloprotein, or is capable of reducing an aerobic concentration of CO2, or is capable of decreasing an aerobic concentration of metal from the aerobic wastewater, or a combination thereof.

2. The system of claim 1, further comprising an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source,
wherein the electrochemical reaction vessel is connected by the at least one wastewater flow path to the anaerobic reaction vessel, the aerobic reaction vessel, or a combination thereof.

3. The system of claim 1, wherein the anaerobic reaction vessel further includes an anaerobic wastewater inlet, an anaerobic wastewater outlet, an anaerobic nutrient inlet, and an anaerobic biomass outlet;
wherein the aerobic reaction vessel further includes an aerobic wastewater inlet, an aerobic wastewater outlet, an aerobic nutrient inlet, and an aerobic biomass outlet;
wherein the at least one wastewater fluid path connects the anaerobic wastewater inlet to the aerobic wastewater outlet, or the at least one wastewater fluid path connects the aerobic wastewater inlet to the anaerobic wastewater outlet.

4. The system of claim 1, further comprising an aerobic biomass fluid flow path connecting the aerobic reaction vessel and the anaerobic reaction vessel.

5. The system of claim 2, wherein the carbon dioxide source includes a carbon dioxide inlet, or wherein the power source includes sunlight, a solar power source, an electrical power source, or a combination thereof.

6. The system of claim 2, wherein the power source is configured to provide a voltage of from about 0.7 Volts to about 10 Volts or a current of from about 60 mA to about 100 mA.

7. The system of claim 2, wherein the electrochemical reaction vessel, the anaerobic reaction vessel, the aerobic reaction vessel, or any combination thereof, has a volume of from about 1000 liters to about 1 million liters; or
wherein the anaerobic concentration ranges from about 10⁷ to about 10⁹ cells per milliliter, or an optical density of about 0.6 to about 1.0; or
wherein the aerobic concentration ranges from about 10⁷ to about 10⁹ cells per milliliter, or an optical density of about 0.6 to about 1.0;
wherein the electrochemical reaction vessel contains an electrochemical reaction buffer, wherein the electrochemical reaction buffer includes an amount of sodium chloride, sodium hydroxide, sodium carbonate, calcium carbonate, potassium carbonate, potassium chloride, potassium hydroxide, magnesium chloride, or a combination thereof; or
wherein the electrochemical reaction vessel, the anaerobic reaction vessel, and the aerobic reaction vessel each independently includes a vessel wall, wherein the vessel wall includes a cement material, a fiberglass material, a fiber material, a steel material, a natural formation, a plastic material, a gel material, or a combination thereof.

8. The system of claim 1, wherein the at least one anaerobic microorganism is capable of reducing a concentration of sulfate and increasing a concentration of sulfide in the anaerobic wastewater; or wherein the at least one anaerobic microorganism is capable of oxidizing the anaerobic concentration of organic compounds in the anaerobic wastewater; or wherein the at least one anaerobic microorganism is capable of producing sulfide; or wherein the at least one aerobic microorganism includes at least one recombinant aerobic microorganism that expresses at least one protein of at least one aerobic genetic pathway, wherein the at least one aerobic genetic pathway provides to the at least one aerobic microorganism one or more of a resistance to a high concentration of heavy metals, a resistance to a low pH level, a production of one or more of an alkaline organic molecule, sodium bicarbonate, ammonia, acetate, and an electron donor; and combinations thereof.

9. The system of claim 1, wherein the at least one anaerobic microorganism includes a microorganism selected from the group consisting of Desulfovibrio desulfuricans, Desulfovibrio vulgaris, Desulfovibrio gigas, Caldivirga maquilingensis, Desulfatibacillum alkenivorans, Desulfotomaculum nigrificans, Desulfococcus multivorans, Thermodesulfovibrio yellowstonii, Desulfovibrio aespoeensis, Desulfovibrio aerotolerans, Desulfovibrio fructosivorans, Desulfococcus oleovorans, Desulfovibrio aminophilus, Desulfovibrio ferrireducens, Desulfovibrio salexigens, Desulfovibrio africanus, Archaeoglobus fulgidus, Desulfococcus biacutus, Desulfatibacillum aliphaticivorans, Desulfatirhabdium butyrativorans, Desulfofaba gelida, Desulfovibrio capillatus, Desulfosporomusa spp., Desulfovibrio acrylicus, Desulfovibrio legalli, Desulfosarcina alkanivorans, Desulfatiferula berrensis, Desulfobacula toluolica, Desulfovibrio frigidus, Desulfofaba hansenii, Desulfovibrio senezii, Desulfovibrio arcticus, Thermodesulfobium narugense, Desulfovibrio burkinensis, Thermodesulfobium acidiphilum, Thermocladium modestius, Caldimicrobium rimae, Desulfosarcina ovata, Thermodesulfobacterium hveragerdense, Desulfovibrio alcoholivorans, Desulfovibrio singaporenus, Caldimicrobium thiodismutans, Desulfosporosinus orientis, Desulfovibrio marinus, Desulfatitalea tepidiphila, Desulfofaba fastidiosa, Desulfovibrio ferrophilus, Desulfovibrio bizertensis, Desulfovibrio biadhensis, Desulfatiferula olefinivorans, Desulfobacula phenolica, Dehalococcoides spp., Geobacteria spp., Acetobacterium woodi, Clostridium ljungdahlii, Moorella thermoacetica, and methanotrophic bacteria, or a combination thereof.

10. The system of claim 8, wherein the at least one aerobic microorganism includes a microorganism selected from the group consisting of an acidophilic microorganism, Galdieria sulphuraria, a bicarbonate producing species, an alkaline producing species, Spirulina platensis, a Cyanobacteria, Synechococcus elongatus, Synechocystis spp., and a recombinant aerobic microorganism that expresses a higher amount of at least one metalloprotein relative to a control aerobic microorganism.

11. The system of claim 1, wherein the anaerobic reaction vessel and the aerobic reaction vessel include a sample port, an optical density reader, a turbidity reader, or a combination thereof.

12. The system of claim 2, wherein the electrochemical reaction vessel, the anaerobic reaction vessel, or the aerobic reaction vessel, or any combination thereof, is mounted on or among one or more vehicles; or
wherein the electrochemical reaction vessel, the anaerobic reaction vessel, or the aerobic reaction vessel, or any combination thereof, is located within 0.3 kilometers of an industrial site and connected to the industrial site by a gas flow path from the industrial site to the carbon dioxide source, or a wastewater flow path from the industrial site to the system wastewater inlet, or a combination thereof; or
wherein the aerobic reaction vessel further comprises a gas flow path connected to the carbon dioxide source, a gas flow path connected to an air source, or a combination thereof.

13. The system of claim 2, further comprising a pH meter connected to at least one of the system wastewater inlet, the system wastewater outlet, the electrochemical wastewater inlet, the electrochemical wastewater outlet, the aerobic wastewater inlet, or the aerobic wastewater inlet, or a combination thereof; or
further comprising a heavy metal detector connected to at least one of the system wastewater inlet, the system wastewater outlet, the electrochemical wastewater outlet, the aerobic wastewater inlet, or the aerobic wastewater inlet, or a combination thereof.

14. A method of treating wastewater comprising:
providing a bioremediation system, wherein the bioremediation system includes:
a system wastewater inlet, a system wastewater outlet, an anaerobic reaction vessel, and an aerobic reaction vessel connected by at least one wastewater flow path;
wherein the anaerobic reaction vessel contains an anaerobic reaction solution,
wherein the anaerobic reaction solution contains an anaerobic concentration of at least one anaerobic microorganism in an anaerobic wastewater, wherein the at least one anaerobic microorganism is capable of reducing an anaerobic concentration of metal in the anaerobic wastewater, increasing an anaerobic pH of the anaerobic wastewater, or reducing an anaerobic concentration of organic compounds in the anaerobic wastewater, or a combination thereof; and
wherein the aerobic reaction vessel contains an aerobic reaction solution, wherein the aerobic reaction solution contains an aerobic concentration of at least one aerobic microorganism in an aerobic wastewater, wherein the at least one aerobic microorganism contains a metalloprotein, or is capable of reducing an aerobic concentration of CO2, or is capable of decreasing an aerobic concentration of metal from the aerobic wastewater, or a combination thereof;
provided the wastewater entering the anaerobic reaction vessel includes one or more heavy metals, producing a sulfide by reacting the at least one anaerobic microorganism with a sulfate compound, and forming at least one metal sulfide compound by reacting one or more of the heavy metals with the sulfide; and
provided the wastewater entering the aerobic reaction vessel includes one or more heavy metals, reacting the one or more heavy metals with the at least one aerobic microorganism.

15. The method of claim 14, further including:
measuring a pH level of wastewater entering the system wastewater inlet; and
provided that the pH level ranges from about 4 or lower, flowing the wastewater from the system inlet into an electrochemical reaction vessel, wherein the electrochemical reaction vessel includes an electrochemical reaction solution, an electrochemical wastewater inlet, an electrochemical wastewater outlet, an anode, a cathode, a power source, and a carbon dioxide source, and the electrochemical reaction solution contains sodium chloride, sodium hydroxide, and sodium carbonate; and
raising the pH level of the electrochemical reaction solution by forming sodium hydroxide and sodium bicarbonate; or
provided that the pH level ranges from about 4.1 to 8.0, flowing wastewater from the system inlet to the anaerobic reaction vessel, the aerobic reaction vessel, or any combination thereof.

16. The method of claim 14, further comprising forming a biomass in the aerobic reaction vessel, and feeding an amount of the biomass into the anaerobic reaction vessel; or further comprising collecting an amount of biomass from the aerobic reaction vessel; or wherein the anaerobic reaction vessel includes a nutrient inlet, adding an amount of carbon dioxide, an amount of methane, or a combination thereof through the nutrient inlet.

17. The method of claim 14, further including,
feeding the wastewater into the anaerobic reaction vessel at a flow rate of from about 50 liters/hour to about 150 liters/hour or more; or
flowing the wastewater through the anaerobic reaction vessel for a residence time of from about 2 hours to about 9 hours; or
feeding an anaerobic reaction vessel effluent into the aerobic reaction vessel at a flow rate of from about 50 liters/hour to about 150 liters/hour or more; or
flowing the wastewater through the aerobic reaction vessel for a residence time of from about 2 hours to about 9 hours; or
provided the anaerobic wastewater in the anaerobic reaction vessel includes an anaerobic concentration one or more heavy metals, reducing the concentration of the one or more heavy metals in the wastewater by from about 1% to about 30% or more, based on the anaerobic concentration; or
provided the aerobic wastewater in the aerobic reaction vessel includes an aerobic concentration one or more heavy metals, reducing the concentration of the one or more heavy metals in the wastewater by from about 1% to about 30% or more, based on the aerobic concentration.

18. The method of claim 14, provided that wastewater leaving the aerobic reaction vessel, the anaerobic reaction vessel, or the system wastewater outlet has a heavy metal content of 0.1 mg/l or more,
flowing the wastewater to the aerobic reaction vessel, the anaerobic reaction vessel, or any combination thereof.

19. The method of claim 14, wherein the one or more heavy metals includes aluminum, iron, zinc, copper, lead, nickel, cadmium, chromium, titanium, vanadium, manganese, cobalt, gallium, germanium, arsenic, zirconium, niobium, and combinations thereof.

20. The method of claim 15, including forming sodium hydroxide and sodium bicarbonate by applying from about 0.7 Volts to about 10 Volts or a current of from about 60 mA to about 100 mA across the anode and the cathode in the presence of sodium chloride and carbon dioxide.
